(19) United States
(12) Patent Application Publication
(10) Pub. No.: US 2014/0043434 A1
(43) Pub. Date: Feb. 13, 2014

(54) IMAGE PROCESSING APPARATUS

(71) Applicants: Motohiro Asano, Osaka-shi (JP); Hiroshi Yamato, Amagasaki-shi (JP)

(72) Inventors: Motohiro Asano, Osaka-shi (JP); Hiroshi Yamato, Amagasaki-shi (JP)

(73) Assignee: KONICA MINOLTA, INC., TOKYO (JP)

(21) Appl. No.: 14/112,504

(22) PCT Filed: Apr. 16, 2012
(86) PCT No.: PCT/JP2012/060235

§ 371 Date: Oct. 17, 2013

(30) Foreign Application Priority Data
May 9, 2011 (JP) 2011-104309

(51) Int. Cl. H04N 13/00

(52) U.S. Cl. CPC H04N 13/0025
USPC 348/42

(57) ABSTRACT

It is an object of the present invention to provide a technique capable of easily executing color matching between respective images obtained by carrying out image-capturing over an object respectively irrespective of an illumination condition of the object. In order to achieve the object, an image processing apparatus according to the present invention includes an acquisition section for acquiring a first image and a second image in which an object is captured, and a processing section for executing a color matching process between the first image and the second image by a conversion for causing a frequency distribution of a first histogram for pixel expression information about the first image to relatively approximate to a frequency distribution of a second histogram for the pixel expression information about the second image, in which the processing section further executes a saturation degree correction process.

### TECHNICAL FIELD

The present invention relates to a technique for carrying out color matching between two color images.

### BACKGROUND ART

In recent years, there is an increasing prevalence of a 3D display device such as a 3D television that allows a stereoscopic view of a displayed image, and there is desired a technique capable of easily carrying out color matching in image groups (stereoscopic images) for color images corresponding to left and right eyes which allow a stereoscopic view for the 3D display device.

Patent Document 1 describes an image processing apparatus capable of enhancing color reproducibility of a color image. In the apparatus, each image is acquired by carrying out image-capturing of a color chart and an irregular illuminance correcting chart by means of a single camera under the same illumination respectively prior to image-capturing for an object. By using each image thus acquired, next, there is made a calibration for acquiring correction information to convert, into target color data, color data on an image obtained by carrying out the image-capturing of the color chart irrespective of the presence of irregular illuminance. Then, a color image in which an object is captured is converted by using the correction information to enhance the color reproducibility of the color image.

### PRIOR ART DOCUMENT

### Patent Document

Patent Document 1: Japanese Patent Application Laid-Open No. 2007-81580

### SUMMARY OF THE INVENTION

### Problems to be Solved by the Invention

In an apparatus for acquiring a left image and a right image by carrying out image-capturing of an object respectively by means of stereo cameras for generating images having different colors, for example, two left and right cameras which are different from each other, in the case in which an illumination condition for the object is always constant, the calibration technique described in the Patent Document 1 is applied to the left image and the right image respectively to enhance the color reproducibility of each image for an absolute standard, thereby enabling the color matching between the left image and the right image to be executed.

In the two cameras which are different from each other, spectral sensitivity characteristics are usually different from each other. Accordingly, in the case in which a light source varies in the calibration and the image-capturing of the object, for example, it is necessary to make a calibration using a dedicated calibration chart again prior to the image-capturing of the object in order to carry out the color matching between the left image and the right image in accordance with the technique described in the Patent Document 1. Every time the illumination condition is changed by the variation in the light source or the like, however, it is not easy to perform the calibration in the Patent Document 1 which uses the dedicated calibration chart.

For this reason, in the case in which the illumination condition varies, there is a problem in that it is hard to perform, by using the technique described in the Patent Document 1, the color matching between the left image and the right image obtained by carrying out the image-capturing of the object by means of the stereo camera having two left and right cameras which are different from each other.

The present invention has been made to solve these problems, and an object of the present invention is to provide a technique that can easily carry out color matching between images in which an object is captured respectively irrespective of an illumination condition for the object.

### Means for Solving the Problems

In order to solve the problems, an image processing apparatus according to a first aspect includes an acquisition section for acquiring a first image and a second image in which an object is captured, and a processing section for executing a color matching process between the first image and the second image by a conversion for causing a frequency distribution of a first histogram for pixel expression information about the first image to relatively approximate to a frequency distribution of a second histogram for pixel expression information about the second image.

An image processing apparatus according to a second aspect is the image processing apparatus according to the first aspect, in which the first image and the second image are images of an object captured by image capturing systems which are different from each other.

An image processing apparatus according to a third aspect is the image processing apparatus according to the first or second aspect, in which the processing section executes the color matching process by setting any one of RGB components, a lightness and a chroma for the first image and the second image as the pixel expression information.

An image processing apparatus according to a fourth aspect is the image processing apparatus according to any one of the first to third aspects, in which the processing section uses a cumulative histogram as the first histogram and the second histogram.

An image processing apparatus according to a fifth aspect is the image processing apparatus according to any one of the first to third aspects, in which the processing section uses a non-cumulative histogram as the first histogram and the second histogram.

An image processing apparatus according to a sixth aspect is the image processing apparatus according to any one of the first to third aspects, in which the processing section acquires a set of a first value of the pixel expression information about the first histogram and a second value of the pixel expression information about the second histogram which correspond to each other for each of a plurality of values of a frequency or a cumulative frequency by setting a value of a frequency or a cumulative frequency of a histogram as a correspondence index, and determines a conversion characteristic for the conversion in such a manner that the first value and the second value after the conversion, for each of the sets thus acquired, are closer to each other as compared with them before the conversion, thereby executing the color matching process.

An image processing apparatus according to a seventh aspect is the image processing apparatus according to any one of the first to sixth aspects, in which the processing section generates a target image derived from at least one of the first image and the second image and executes the color matching process by a conversion for causing the frequency distribution of the first histogram and the frequency distribution of the second histogram to approximate to a frequency distribution of a histogram for the pixel expression information about the target image.

An image processing apparatus according to an eighth aspect is the image processing apparatus according to any one of the first to seventh aspects, in which the processing section executes the color matching process based on a first part of the first image and a second part of the second image.

An image processing apparatus according to a ninth aspect is the image processing apparatus according to the eighth aspect, in which the first part and the second part correspond to almost the same part of the object, respectively.

An image processing apparatus according to a tenth aspect is the image processing apparatus according to the eighth or ninth aspect, in which the first part is a portion of the first image other than a first occlusion area for the second image, and the second part is a portion of the second image other than a second occlusion area for the first image.

An image processing apparatus according to an eleventh aspect is the image processing apparatus according to the ninth aspect, in which the processing section identifies the first part and the second part by a pattern matching process between the first image and the second image or a stereo calibration process, respectively.

An image processing apparatus according to a twelfth aspect is the image processing apparatus according to the tenth aspect, in which the processing section executes a corresponding point retrieval process between the first image and the second image, thereby identifying the first occlusion area and the second occlusion area, respectively.

An image processing apparatus according to a thirteenth aspect is the image processing apparatus according to any one of the first to twelfth aspects, in which the processing section further executes a saturation degree correction process for causing a degree of saturation in any one of the first image and the second image which has a lower degree of saturation to approximate to the degree of saturation of the other image, the degree of saturation expressing a rate of pixels having a saturated value of the pixel expression information.

An image processing apparatus according to a fourteenth aspect is the image processing apparatus according to the thirteenth aspect, in which when a converting gamma table is defined with an input/output relationship for causing each value of the pixel expression information about the other image before the conversion to correspond to each value of the pixel expression information after the conversion, the processing section executes the saturation degree correction process based on an output value of the converting gamma table corresponding to an end of a range of an input value in the converting gamma table.

An image processing apparatus according to a fifteenth aspect is the image processing apparatus according to the thirteenth aspect, in which the processing section executes the saturation degree correction process based on a frequency of a histogram for the pixel expression information about the other image, the frequency corresponding to an end of a range of the pixel expression information in the histogram.

An image processing apparatus according to a sixteenth aspect is the image processing apparatus according to any one of the seventh to twelfth aspects, in which the processing section sets, as the target image, either of the first image and the second image which has smaller color fogging.

An image processing apparatus according to a seventeenth aspect is the image processing apparatus according to any one of the seventh to twelfth aspects, in which the processing section sets, as the target image, either of the first image and the second image which is captured by a higher-resolution image capturing system.

An image processing apparatus according to an eighteenth aspect is the image processing apparatus according to any one of the first to seventeenth aspects, in which the processing section executes the color matching process by setting any piece of information among RGB components, a lightness and a chroma for the first image and the second image as the pixel expression information, and further executes the color matching process by setting, as the pixel expression information, a piece of information other than the any piece of information among the RGB components, the lightness and the chroma for the first image and the second image which are subjected to the color matching process.

An image processing apparatus according to a nineteenth aspect is the image processing apparatus according to any one of the first to eighteenth aspects, in which for a focused block in blocks obtained by dividing an image area of the first image into a plurality of blocks and a corresponding block in blocks obtained by dividing an image area of the second image into the plurality of blocks, the corresponding block having an arrangement relationship corresponding to the focused block, the processing section executes a color matching process between the focused block in the first image and the focused block in the second image by a conversion for each block which causes a frequency distribution of a histogram for the pixel expression information about the focused block to relatively approximate to a frequency distribution of a histogram for the pixel expression information about the corresponding block.

An image processing apparatus according to a twentieth aspect is the image processing apparatus according to the nineteenth aspect, in which for each of the first image and the second image, the processing section (a) acquires a new conversion characteristic of the conversion for each block for each of the plurality of blocks by assigning weights in accordance with mutual distances between the plurality of blocks to the conversion characteristic of the conversion for each of the plurality of blocks and performing a mutual application between the plurality of blocks, and (b) converts a value of the pixel expression information based on the new conversion characteristic of the conversion for each block for each of the plurality of blocks.

An image processing apparatus according to a twenty-first aspect is the image processing apparatus according to any one of the first to twentieth aspects, in which the acquisition section acquires a third image and a fourth image captured at a time different from a time when the first image and the second image have been captured, and the processing section executes the color matching process between the third image and the fourth image to acquire a conversion characteristic and corrects a conversion characteristic of the color matching process between the first image and the second image based on the conversion characteristic obtained by the color matching process between the third image and the fourth image.

A program according to a twenty-second aspect is executed in a computer provided in an image processing apparatus, thereby causing the image processing apparatus to function as the image processing apparatus according to any one of the first to twenty-first aspects.

An image processing method according to a twenty-third aspect includes an acquisition step of acquiring a first image and a second image in which an object is captured, and a processing step of executing a color matching process between the first image and the second image by a conversion for causing a frequency distribution of a first histogram for pixel expression information about the first image to relatively approximate to a frequency distribution of a second histogram for the pixel expression information about the second image.

### Effects of the Invention

By the invention according to any of the first to twenty-third aspects, for the first image and the second image in which the object is captured, the frequency distribution of the first histogram for the first image is caused to relatively approximate to the frequency distribution of the second histogram for the second image so that the color matching process for the first image and the second image is executed. The color matching process can be carried out every image-capturing of the object because the dedicated calibration chart is not required. Irrespective of the illumination condition for the object, therefore, it is possible to easily carry out the color matching between the images in which the object is captured by the different cameras from each other, respectively.

### BRIEF DESCRIPTION OF DRAWINGS

FIG. 1 is a view showing a schematic structure of an image processing system using an image processing apparatus according to an embodiment.

FIG. 2 is a functional block diagram showing an example of a structure of a main part in the image processing apparatus according to the embodiment.

FIG. 3 is a view showing an example of an input image.

FIG. 4 is a view showing an example of the input image.

FIG. 5 is a chart for explaining a process for generating a converting gamma table using a cumulative histogram.

FIG. 6 is a chart showing an example of a converting gamma table for an R value of a subject image.

FIG. 7 is a chart showing an example of a converting gamma table for an R value of a target image.

FIG. 8 is a chart showing examples of cumulative histograms for the target images, respectively.

FIG. 9 is a chart for explaining a process for generating a converting gamma table using a non-cumulative histogram.

FIG. 10 is a chart showing an example of a converting gamma table for an R value of a subject image.

FIG. 11 is a view showing an example of a common area in an input image.

FIG. 12 is a view showing an example of the common area in the input image.

FIG. 13 is a view showing an example of a portion from which an occlusion area of the input image is excluded.

FIG. 14 is a view showing an example of the portion from which the occlusion area of the input image is excluded.

FIG. 15 is a diagram showing an example of a plurality of partial areas in the input image.

FIG. 16 is a chart showing an example of mutual weights of the partial areas.

FIG. 17 is a diagram showing an example of the partial areas in the input image.

FIG. 18 is a diagram showing an example of the partial areas in the input image.

FIG. 19 is a diagram showing an example of the partial areas in the input image.

FIG. 20 is a diagram for explaining an example of a weighting process in the partial areas.

FIG. 21 is a chart for explaining an example of a degree of saturation based on the converting gamma table.

FIG. 22 is a chart for explaining an example of the degree of saturation based on the converting gamma table.

FIG. 23 is a chart for explaining an example of the degree of saturation based on the converting gamma table.

FIG. 24 is a chart for explaining an example of the degree of saturation based on the converting gamma table.

FIG. 25 is a chart showing an example of a calibration table.

FIG. 26 is a chart showing an example of a corrected converting gamma table of an R value of a subject image.

FIG. 27 is a chart showing an example of a corrected converting gamma table of a G value of the subject image.

FIG. 28 is a chart showing an example of a corrected converting gamma table of a B value of the subject image.

FIG. 29 is a chart showing an example of a corrected converting gamma table of each color component of a target image.

FIG. 30 is a chart for explaining an example of a degree of saturation based on a non-cumulative histogram.

FIG. 31 is a chart showing an example of a correction table.

FIG. 32 is a view for explaining a concept of a chronological image.

FIG. 33 is a chart showing an example of a converting gamma table in the chronological image.

FIG. 34 is a diagram showing an example of an operational flow of the image processing apparatus according to the embodiment.

FIG. 35 is a diagram showing an example of the operational flow of the image processing apparatus according to the embodiment.

FIG. 36 is a diagram showing an example of the operational flow of the image processing apparatus according to the embodiment.

FIG. 37 is a diagram showing an example of the operational flow of the image processing apparatus according to the embodiment.

FIG. 38 is a diagram showing an example of the operational flow of the image processing apparatus according to the embodiment.

FIG. 39 is a diagram showing an example of the operational flow of the image processing apparatus according to the embodiment.

### EMBODIMENT FOR CARRYING OUT THE INVENTION

<Regarding Embodiment>

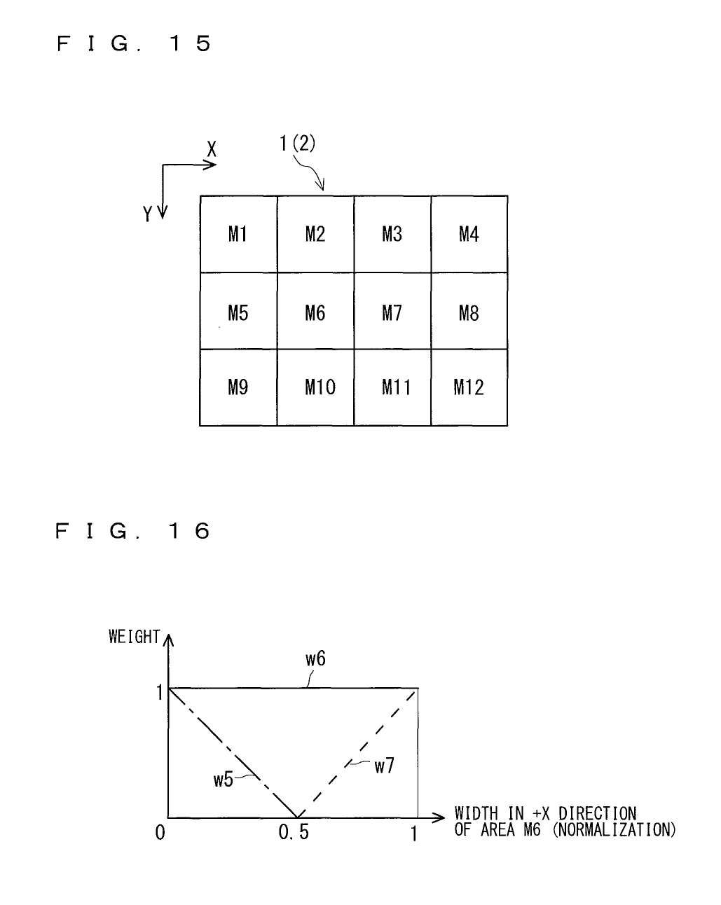

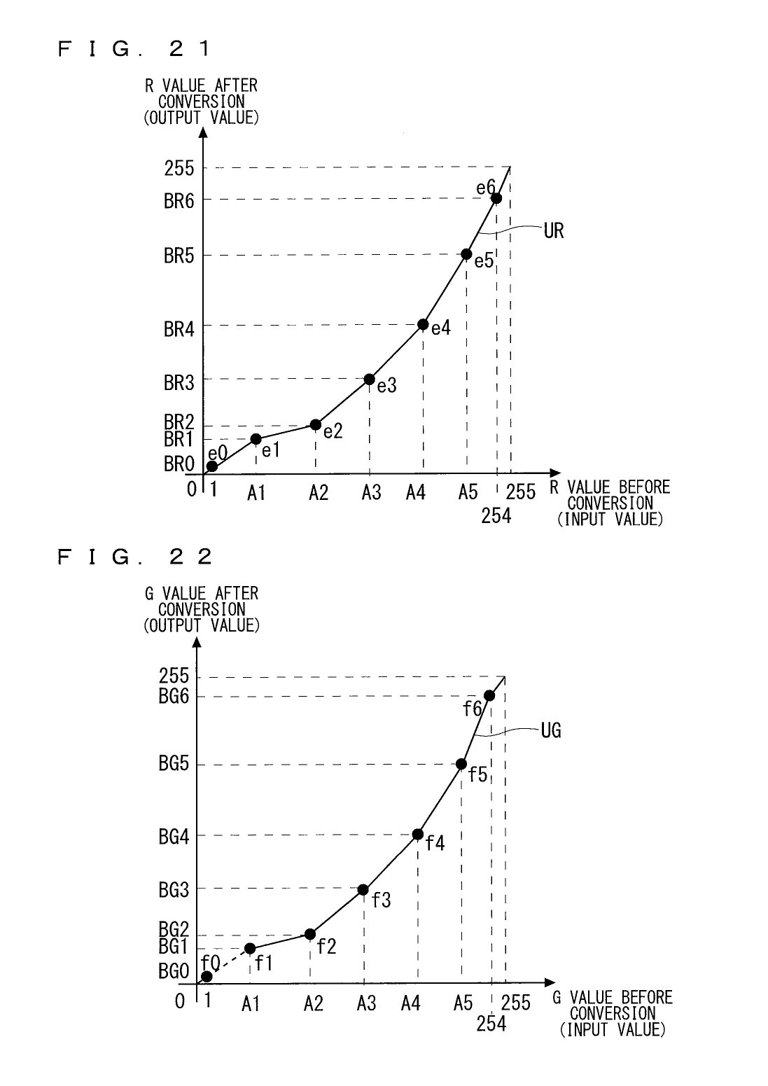

An embodiment according to the present invention will be described below based on the drawings. In the drawings, the same reference numerals are given to portions having the same structures and functions, and repetitive explanation will be omitted in the following description. Moreover, each of the drawings is shown typically and sizes, a positional relationship and the like of things displayed on an image in each of the drawings are not always illustrated accurately, for example. For convenience of the description, two orthogonal X and Y axes to each other are shown in FIGS. 15 and 20.

<(1) Regarding Image Processing System 100A>

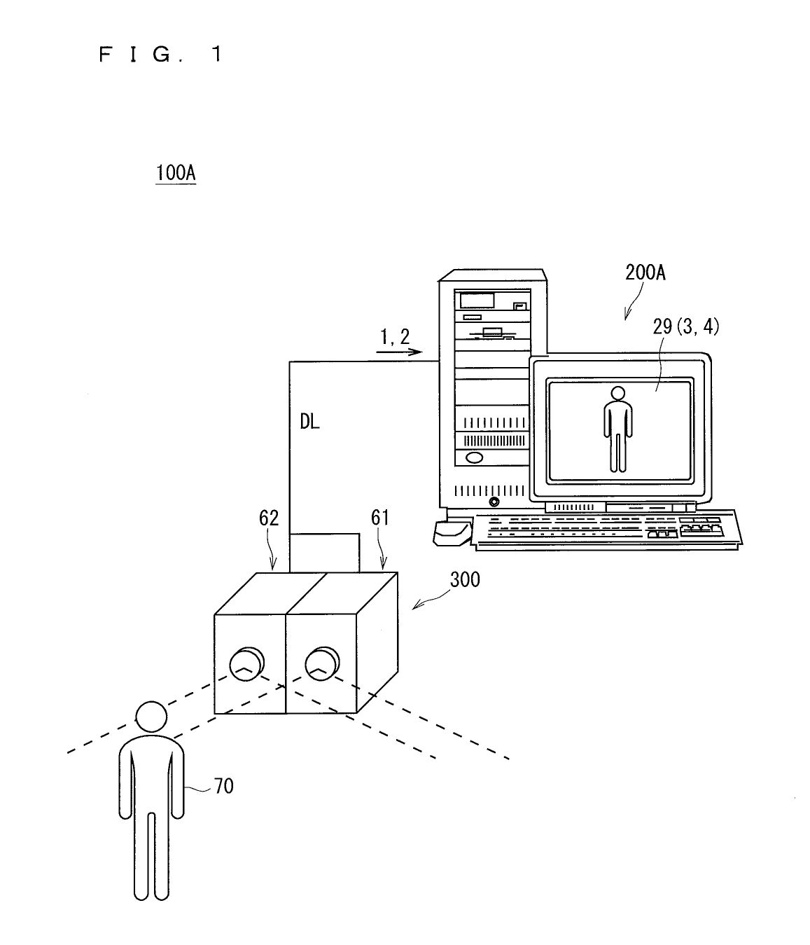

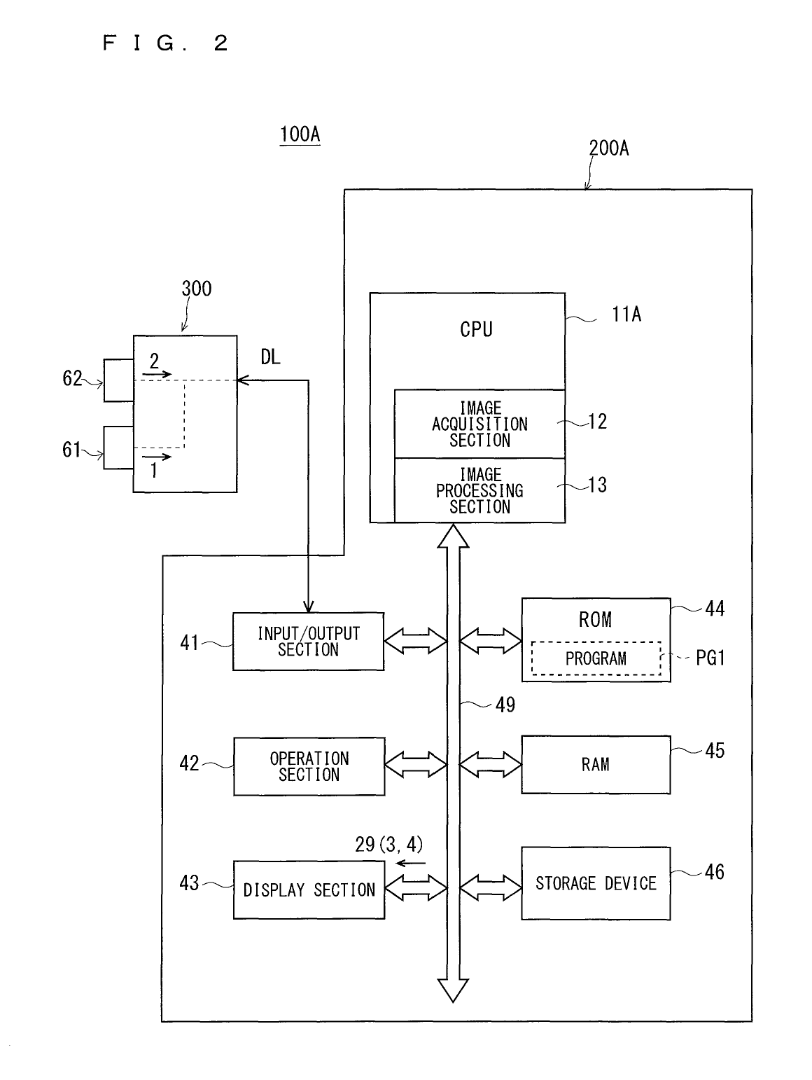

FIG. 1 is a view showing a schematic structure of an image processing system 100A using an image processing apparatus 200A according to an embodiment. As shown in FIG. 1, the image processing system 100A mainly includes a stereo camera 300 and the image processing apparatus 200A. In the image processing system 100A, the image processing apparatus 200A acquires an input image 1 to be a first image and an input image 2 to be a second image (FIGS. 1 and 2) which are obtained by carrying out image-capturing of an object 70 by means of the stereo camera 300, and the image processing apparatus 200A processes the input images 1 and 2, thereby executing a color matching process between the input images 1 and 2. The image processing apparatus 200A generates output images 3 and 4 (FIGS. 1 and 2) constituting a stereoscopic image 29 by the color matching process. The stereoscopic image 29 thus generated is displayed on a display section 43 of the image processing apparatus 200A (FIG. 2).

<(1-1) Regarding Stereo Camera 300>

As shown in FIG. 1, the stereo camera 300 mainly includes a first camera 61 and a second camera 62. Moreover, the first camera 61 and the second camera 62 mainly include an image-capturing optical system which is not shown and a control processing circuit having a color image-capturing device, respectively. The first camera 61 and the second camera 62 are provided apart from each other by a predetermined base line length, and processes information about a light beam incident on the image-capturing optical system from an object by the control processing circuit or the like synchronously, thereby generating the input images 1 and 2 to be digital color images. An image size of each of the input images 1 and 2 is a predetermined size of 3456 pixels×2592 pixels or the like, for example, and the input images 1 and 2 constitute a stereo image of the object 70.

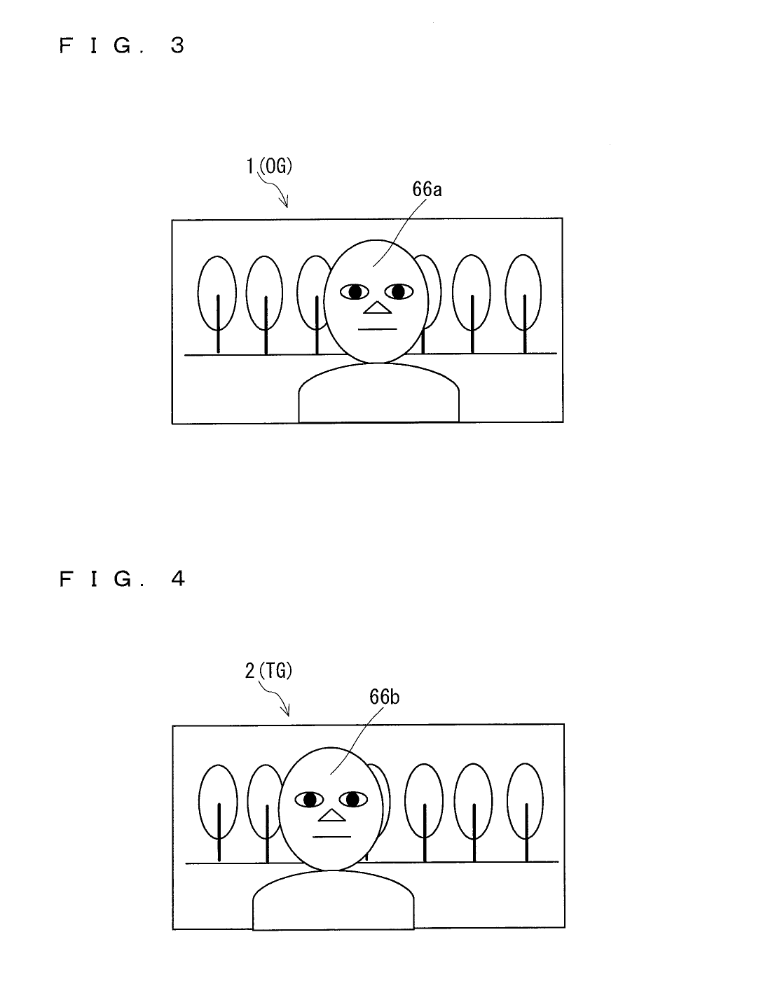

FIGS. 3 and 4 are views showing an example of the input image 1 and the input image 2, respectively. As shown in FIGS. 3 and 4, images of common objects including a foreground object and a background object are captured on the input images 1 and 2, respectively. A foreground object image 66a (FIG. 3) is an image of the foreground object in the input image 1 and a foreground object image 66b (FIG. 4) is an image of the foreground object in the input image 2. A background of the foreground object is imaged as a background object image on each of a periphery of the foreground object image 66a in the input image 1 and a periphery of the foreground object image 66b in the input image 2.

Even if the numbers of pixels in the input images 1 and 2 are different from each other, the usability of the present invention is not impaired. Even if optical performances of respective image-capturing optical systems of the first camera 61 and the second camera 62 are different from each other, moreover, the usability of the present invention is not impaired. The optical performance includes OTF (Optical Transfer function), an image-capturing magnification, an aberration, a shading characteristic and the like, for example.

Various operations of the stereo camera 300 are controlled based on a control signal supplied from the image processing apparatus 200A through an input/output section 41 (FIG. 2) and a communication line DL (FIGS. 1 and 2). The communication line DL may be a wired line or a wireless line. Moreover, the input images 1 and 2 which are generated are supplied to the input/output section 41 of the image processing apparatus 200A through the communication line DL. In addition, the stereo camera 300 may have such a structure as to continuously capture an image of an object sequentially over time while synchronizing the first camera 61 and the second camera 62 with each other, thereby enabling a plurality of input images 1 and a plurality of input images 2 to be generated.

<(1-2) Regarding Image Processing Apparatus 200A>

FIG. 2 is a functional block diagram showing an example of a structure of a main part in the image processing apparatus 200A according to the embodiment. As shown in FIG. 2, the image processing apparatus 200A mainly includes a CPU 11A, the input/output section 41, an operation section 42, a display section 43, a ROM 44, a RAM 45, and a storage device 46, and is implemented by, for example, the execution of a program in a general-purpose computer or the like.

The input/output section 41 includes an input/output interface such as a USB interface or a Bluetooth (registered trademark) interface, a multimedia drive, an interface such as a network adapter for connection to a LAN or internet and the like, for example, and serves to transmit and receive data to and from the CPU 11A. Specifically, the input/output section 41 supplies, for example, various control signals used for the CPU 11A to control the stereo camera 300 to the stereo camera 300 connected to the input/output section 41 via the communication line DL or the like.

Moreover, the input/output section 41 supplies, to the image processing apparatus 200A, the input image 1 and the input image 2 which are captured by the stereo camera 300, respectively. The input/output section 41 also accepts a storage medium such as an optical disk in which the input image 1 and the input image 2 are stored in advance, thereby supplying the input image 1 and the input image 2 to the image processing apparatus 200A, respectively.

The operation section 42 is constituted by a keyboard, a mouse or the like, for example, and an operator operates the operation section 42, thereby carrying out setting of various control parameters to the image processing apparatus 200A, setting of various operation modes of the image processing apparatus 200A and the like. Moreover, function sections of the image processing apparatus 200A are configured so as to enable the execution of a process corresponding to each of the operation modes set through the operation section 42.

The display section 43 is constituted by a liquid crystal display screen for 3D display compliant with a 3D display system such as a parallax barrier system, for example. Moreover, the display section 43 includes an image processing section which is not shown and serves to convert the stereoscopic image 29 constituted by the output image 3 and the output image 4 into an image format corresponding to the 3D display system in the display section 43. The display section 43 displays, on a display screen thereof, the stereoscopic image subjected to a necessary conversion process by the image processing section.

As the 3D display system in the display section 43, for example, it is also possible to adopt a 3D display system for alternately switching an image for a left eye and an image for a right eye at a high speed to display them on the display section 43 and observing a stereoscopic image displayed on the display section 43 through special glasses capable of alternately opening and closing shutter sections corresponding to the left eye and the right eye respectively in synchronization with the switching. The display section 43 can also display an image supplied from the stereo camera 300, an image generated by the image processing apparatus 200A, various setting information about the image processing apparatus 200A, a control GUI (Graphical User Interface) and the like so as to enable an observer to visually recognize them as a two-dimensional image or character information.

The ROM (Read Only Memory) 44 is a read only memory, and stores a program PG1 for operating the CPU 11A, and the like. Instead of the ROM 44, a non-volatile memory (for example, a flash memory) of a freely readable and writable system may be used.

The RAM (Random Access Memory) 45 is a volatile memory of a freely readable and writable system and functions as an image storage section for temporarily storing various images acquired by the image processing apparatus 200A, the stereoscopic image 29 generated by the image processing apparatus 200A and the like, a work memory for temporarily storing processing information of the CPU 11A, and the like.

For example, the storage device 46 is constituted by a non-volatile memory of a freely readable and writable system such as a flash memory, a hard disk device, or the like, and permanently records information including various control parameters, various operation modes of the image processing apparatus 200A, and the like.

The CPU (Central Processing Unit) 11A is a control processing device that collectively controls each of function sections of the image processing apparatus 200A, and serves to execute a control and a process in accordance with a program PG1 stored in the ROM 44 or the like. The CPU 11A also functions as an image acquisition section 12 to be an acquisition section and an image processing section 13 to be a processing section as will be described below. The CPU 11A carries out a conversion for causing a frequency distribution of a histogram (a first histogram) for pixel expression information about the input image 1 to relatively approximate to a frequency distribution of a histogram (a second histogram) for pixel expression information about the input image 2 by means of these function sections or the like. The CPU 11A executes a color matching process for causing color data (color information) on the input image 1 to relatively approximate to color data (color information) on the input image 2 by the conversion. The CPU 11A generates the output images 3 and 4 through the color matching process. Moreover, the CPU 11A controls the image-capturing operation of the stereo camera 300, and furthermore, controls the display section 43 to display various images, a result of a calculation, various control information and the like on the display section 43.

Moreover, the CPU 11A, the input/output section 41, the operation section 42, the display section 43, the ROM 44, the RAM 45, the storage device 46, and the like, are electrically connected to one another via a signal line 49, respectively. Therefore, the CPU 11A can execute, in a predetermined timing, a control of the stereo camera 300 through the input/output section 41, an acquisition of image information from the stereo camera 300, a display on the display section 43 and the like, for instance. In an example of the structure shown in FIG. 2, each of the function sections such as the image acquisition section 12 and the image processing section 13 is implemented by executing a predetermined program through the CPU 11A. However, each of these function sections may be implemented by a dedicated hardware circuit or the like, for example.

<(2) Regarding Operation of Image Processing Apparatus 200A>

<(2-1) Regarding Outline of Operation>

FIG. 34 is a diagram showing an example of an outline of an operational flow S10A of the image processing apparatus 200A according to the embodiment. The image acquisition section 12 of the image processing apparatus 200A accepts an operation of a user utilizing the operation section 42, thereby acquiring the input images 1 and 2 obtained by the stereo camera 300, respectively (Step S10 in FIG. 34). The input images 1 and 2 are images obtained by carrying out image-capturing of an object by means of the first camera 61 and the second camera 62 to be different image-capturing systems from each other, respectively.

When the input images 1 and 2 are acquired, the image processing section 13 carries out the color matching process for causing the color data (color information) on the input image 1 to relatively approximate to the color data (color information) on the input image 2 by the conversion for causing the frequency distribution of the histogram for the pixel expression information about the input image 1 to relatively approximate to the frequency distribution of the histogram for the pixel expression information about the input image 2 (Step S20 in FIG. 34).

In the present application, any piece of information of RGB components, a lightness and a chroma for an image is also referred to as “pixel expression information”.

When the color matching process is carried out, the image processing section 13 executes a process for correcting a degree of saturation which causes a degree of saturation for any one of the input images 1 and 2 having a lower degree of saturation expressing a rate of pixels having saturated value of the pixel expression information (RGB components) to approximate to a degree of saturation of the other image (Step S30 in FIG. 34), and generates the output images 3 and 4 respectively (Step S40 in FIG. 34).

<(2-2) Regarding Color Matching Process>

The image processing apparatus 200A carries out the color matching process between the input image 1 and the input image 2 based on the histograms for the pixel expression information about the input images 1 and 2. Referring to the present application, in order to distinguish a cumulative histogram expressing a relationship between an input value and a cumulative frequency (the cumulative number of pixels) corresponding to the input value from a histogram expressing a relationship between an input value and a frequency (the number of pixels) corresponding to the input value, the latter histogram will be appropriately referred to as a “normal histogram” or a “non-cumulative histogram”.

In the present application, moreover, a term of “histogram” is simply used appropriately as a collective term for the cumulative histogram and the normal histogram (the non-cumulative histogram).

The input images 1 and 2 are images in which the same object is captured, respectively. For this reason, shapes of the histograms for the pixel expression information about both of the images should be nearly close to each other essentially. Accordingly, also in the case in which colors in the input images 1 and 2 are different from each other due to a variation in white balance setting or the like, for example, the image processing apparatus 200A can cause colors of both of the images to approximate to each other by a conversion for causing the histograms of both of the images to be close to each other (a conversion for roughly matching the shapes of the histograms).

In more detail, the image processing apparatus 200A first generates a converting gamma table for converting color information about the input images 1 and 2 in order to cause the histograms of the respective pixel expression information about the input images 1 and 2 to relatively approximate to each other. Then, the image processing apparatus 200A converts the color information about the input images 1 and 2 by using the converting gamma table, thereby carrying out a color matching process for the input images 1 and 2. The converting gamma table will be described below.

In the case in which the numbers of pixels of the input images 1 and 2 are different from each other, the histograms for the input images 1 and 2 are normalized based on the numbers of the pixels of the images respectively and are then used in the process for causing the respective histograms to relatively approximate to each other. Even if the numbers of the pixels of the input images 1 and 2 are different from each other, accordingly, the usability of the present invention is not impaired.

According to the image processing apparatus 200A, a dedicated calibration chart for the color matching process is not required. Accordingly, a color calibration in a production of the stereo camera 300 is not required, and furthermore, the color matching process can also be carried out every time for each image-capturing of the object through the stereo camera 300 irrespective of a change in the illumination condition for the object.

<Regarding Setting of Target Image>

The image processing apparatus 200A generates a target image derived from at least one of the input images 1 and 2 from at least one of the input images 1 and 2 and uses the target image as a target image for giving a target histogram in the process for causing the histograms to approximate to each other prior to the start of the color matching process. The target image may be one of the input images 1 and 2 themselves. Moreover, the target image may be generated based on the input images 1 and 2, for example, based on an image obtained by averaging pixel values of the input images 1 and 2. Even if another image obtained by previously carrying out the image-capturing of the same object as the input images 1 and 2 is set to be the target image, moreover, the usability of the present invention is not impaired.

In other words, the image processing apparatus 200A executes the process for causing the histogram for one of the input images 1 and 2 to approximate to the other histogram in some cases, and executes the process for causing both of the histograms for the input images 1 and 2 to approximate to a histogram for another image in the other cases. In the present application, furthermore, either of the input images 1 and 2 which is not set to be the target image is also referred to as a “subject image”.

FIG. 8 is a chart showing examples of cumulative histograms for the target image respectively, and cumulative histograms CH1 and CH2 indicate cumulative histograms for values of R components (R values) of the input images 1 and 2. The cumulative histogram CHT indicates a cumulative histogram for an R value of another image (the target image) generated based on the input images 1 and 2. In the examples shown in FIG. 8, the image processing section 13 of the image processing apparatus 200A sets both of the input images 1 and 2 as subject images. The image processing section 13 generates, for each of the input images 1 and 2, a converting gamma table for giving a conversion to cause each of the cumulative histograms CH1 and CH2 to approximate to the cumulative histogram CHT.

Next, the generation (identification) of the target image will be specifically described. The image processing section 13 sets, as the target image, either of the input images 1 and 2 which has smaller color fogging corresponding to a preset operation mode. The image processing section 13 can function as a color fogging amount determining section which is not shown and serves to determine a color fogging amount of each image based on a feature quantity of a signal distribution of the pixel expression information for the respective image data on the input images 1 and 2 by using the method disclosed in Japanese Patent Application Laid-Open No. 2001-229374 or the like, for example. Moreover, the image processing section 13 can also function as a target image identification section which is not shown and serves to set, as a target image, either of the input images 1 and 2 that has a smaller color fogging amount as a result of the determination of the color fogging amount.

In addition, the image processing section 13 sets, as the target image, either of the input images 1 and 2 which is captured by a higher-resolution image-capturing system corresponding to a preset operation mode. In other words, the image processing section 13 identifies the image (the input image 1) of the first camera 61 as the target image, thereby generating the target image in the case in which the first camera 61 has a higher-resolution image-capturing optical system in the first camera 61 and the second camera 62, for example.

In an image-capturing system having a high resolution, that is, an image capturing system having a large number of pixels, generally, there are used a lens having various optical performances which are excellent as compared with an image-capturing system having a low resolution, that is, an image-capturing system having a small number of pixels and a processing circuit. Accordingly, an image captured by the image-capturing system having a high resolution is more excellent in image quality such as an aberration of a captured image or presence of a false color. If the image obtained by an image-capturing system having a high resolution is set to be the target image, therefore, the result of the color matching process for the input images 1 and 2 can be improved more greatly.

The image processing section 13 can also select and designate the target image based on information for designating the target image by a user with the use of the operation section 42 corresponding to the operation mode.

<(2-2-1) Color Matching Process using Cumulative Histogram>

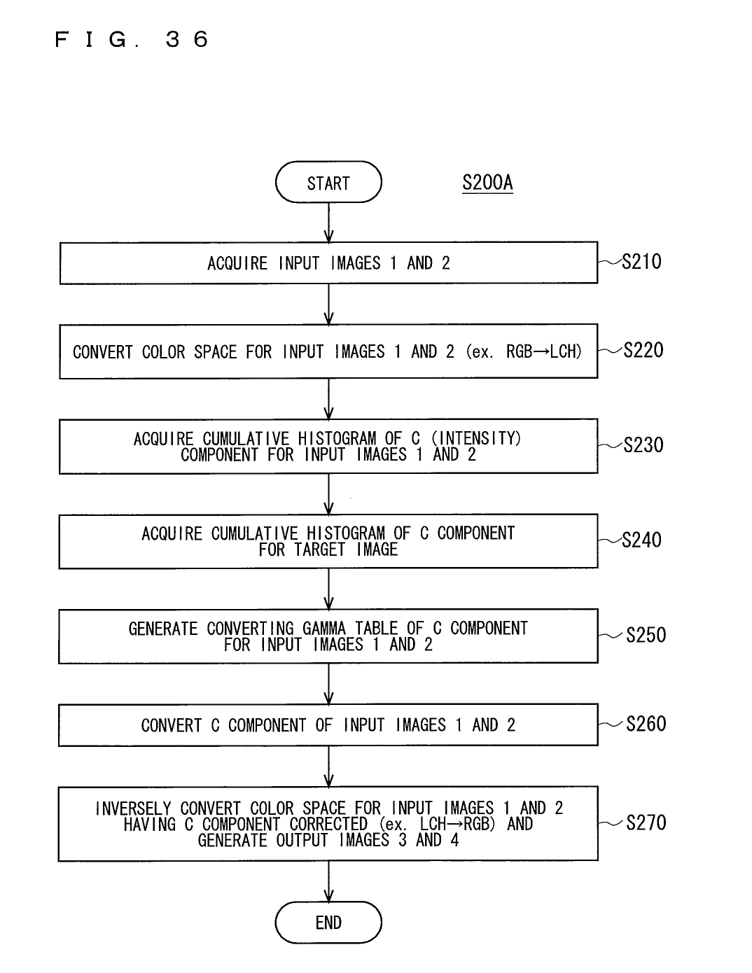

Next, description will be given with appropriate reference to an operational flow of FIG. 35 for a color matching process using a cumulative histogram by taking, as an example, the case in which the input image 1 is set to be the subject image OG and the input image 2 is set to be the target image TG as shown in FIGS. 3 and 4. FIG. 35 is a diagram showing an example of an operational flow S100A related to the color matching process using the cumulative histogram by the image processing apparatus 200A according to the embodiment. In the present application, each pixel expression information about an image is expressed in 8 bits.

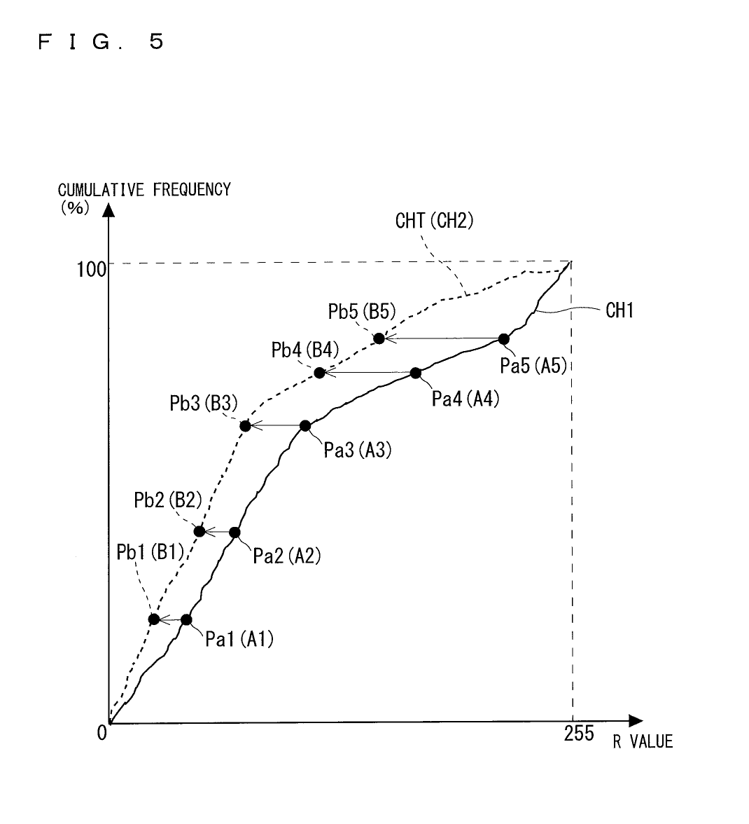

Moreover, FIG. 5 is a chart for explaining a process for generating a converting gamma table using a cumulative histogram. In FIG. 5, explanation is given by taking, as an example, a process for generating a converting gamma table for an R component (an R value) of an image.

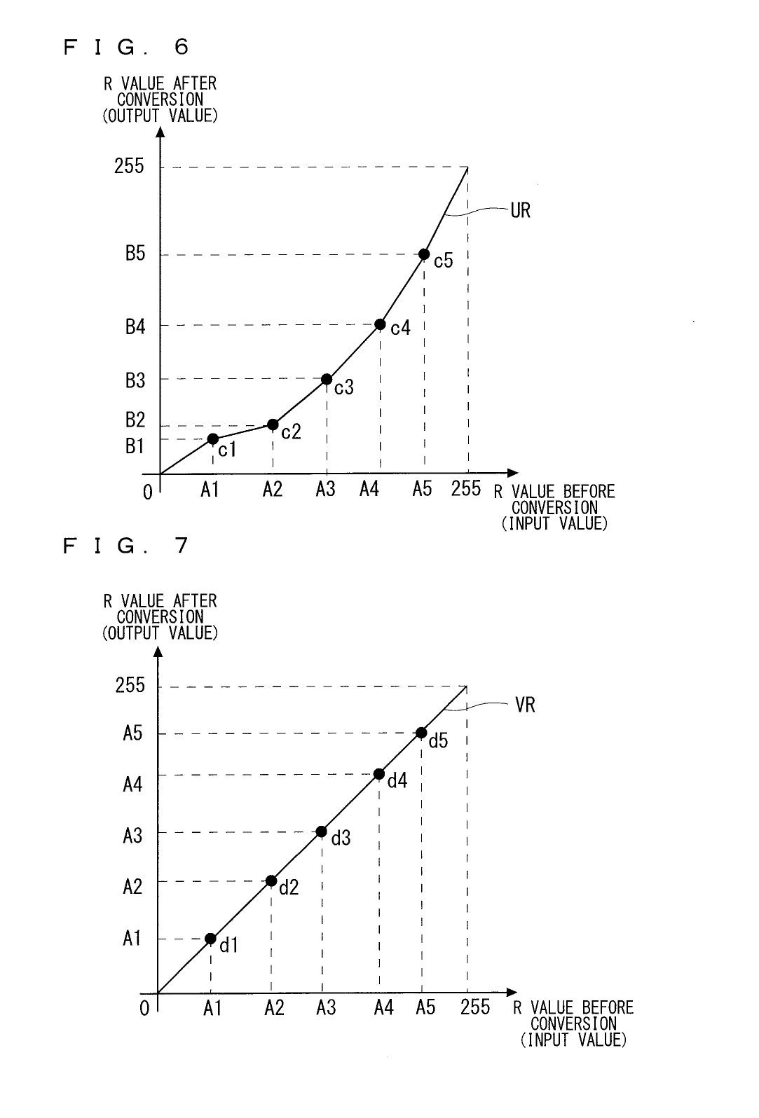

Furthermore, FIG. 6 is a chart showing an example of a converting gamma table UR for the R value of the input image 1 (the subject image OG) and FIG. 7 is a chart showing an example of a converting gamma table VR for the R value of the input image 2 (the target image TG).

When the color matching process is started so that the image acquisition section 12 acquires the input images 1 and 2 (Step S110 in FIG. 35), the image processing section 13 acquires a cumulative histogram for each of the RGB components for each of the input images 1 and 2 (Step S120 in FIG. 35). In FIG. 5, there are shown the cumulative histogram CH1 for the R value of the input image 1 and the cumulative histogram CH2 for the R value of the input image 2. Moreover, the cumulative histograms CH1 and CH2 are normalized by a maximum value of a cumulative frequency, respectively.

Next, the image processing section 13 acquires the cumulative histogram for each of the RGB components for the target image TG, that is, the input image 2 (Step S130 in FIG. 35). As shown in FIG. 5, the cumulative histogram CHT for the R value of the target image TG is also equivalent to the cumulative histogram CH2.

When a cumulative histogram of each color component for each of the subject image OG and the target image TG is acquired, the image processing section 13 generates the converting gamma table for each of the RGB components for the input images 1 and 2 (Step S140 in FIG. 35).

In the case in which the converting gamma tables UR and VR are generated for the R value (R component), the image processing section 13 sets a plurality of points such as points Pa1 to Pa5 on the cumulative histogram CH1 at the Step S140. R values for the points Pa1 to Pa5 are represented by A1 to A5, respectively.

When the points Pa1 to Pa5 are set, the image processing section 13 identifies and acquires points Pb1 to Pb5 on the cumulative histogram CH2 corresponding to the points Pa1 to Pa5 respectively by setting the value of the cumulative frequency as a correspondence index. Herein, the cumulative frequencies of the R values for the points Pa1 to Pa5 have equal values to those of the cumulative frequencies of the R values for the points Pb1 to Pb5, respectively.

Thus, the image processing section 13 acquires, for each of the values of the cumulative frequency, a set of the value of the pixel expression information about the cumulative histogram CH1 and the value of the pixel expression information about the cumulative histogram CH2 which correspond to each other by setting the value of the cumulative frequency as the correspondence index.

When the points Pb1 to Pb5 are identified, the image processing section 13 identifies points c1 to c5 corresponding to the R values A1 to A5 of the input image 1 and R values B1 to B5 of the input image 2 as shown in FIG. 6. The image processing section 13 identifies an input/output relationship for causing each R value (an input value) of the input image 1 to correspond to each R value (an output value) of the output image 3 based on the points c1 to c5. The identified input/output relationship (which is also referred to as a “conversion characteristic”) is also referred to as a “converting gamma table”).

The converting gamma table UR is identified as a polygonal line passing through the points c1 to c5, an approximation curve or the like, for example. In the case in which the R value has 8 bits, for example, the converting gamma table UR is generated in such a manner that an input value of 0 corresponds to an output value of 0 and an input value of 255 corresponds to an output value of 255. Converting gamma tables for other pixel expression values are also generated in the same manner.

Herein, since the input image 2 is the target image TG, the input image 2 is exactly generated as the output image 4. Accordingly, the converting gamma table VR for the input image 2 forms a straight line having a gradient of 1 in such a manner that it is identified by points d1 to d5 in FIG. 7. In the case in which the input image is the target image itself, thus, a converting gamma table for a non-conversion is created.

As described above, the converting gamma table UR for converting the input image 1 to the output image 3 has a conversion characteristic which is identified to cause the values of the cumulative histogram CH1 for the R value of the input image 1 (the subject image OG) and the cumulative histogram CH2 for the R value of the input image 2 (the target image TG) to approximate to each other.

When the converting gamma tables for the respective RGB components are generated for the input images 1 and 2 respectively, the image processing section 13 uses the respective converting gamma tables thus generated to convert the respective RGB components of the input images 1 and 2, thereby generating the output images 3 and 4 respectively (Step S150 in FIG. 35) to end the color matching process.

In the cumulative histogram, the value of the pixel expression information corresponds to the value of cumulative frequency corresponding in a one-to-one relationship. If the cumulative histogram is used as described above, accordingly, it is possible to cause the cumulative histogram of the subject image OG to relatively approximate to the cumulative histogram of the target image TG by identifying a plurality of points other than a feature point such as a peak of the cumulative histogram, for example.

The respective cumulative histograms are caused to approximate to each other based on the points. For this reason, if the cumulative histogram is used, it is possible to carry out the color matching more accurately as compared with the case in which the normal histogram is used, for example. In the case in which the color matching process is executed by setting any of the RGB components as the pixel expression information, the color matching process is carried out for the other components in the RGB components respectively in order to maintain a balance among the RGB color components.

<(2-2-2) Color Matching Process Using Non-Cumulative Histogram>

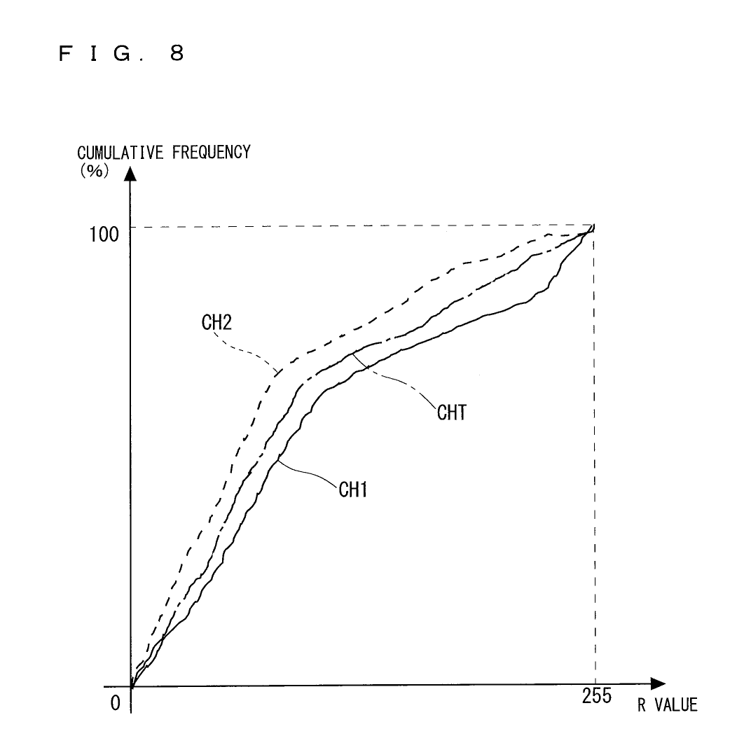

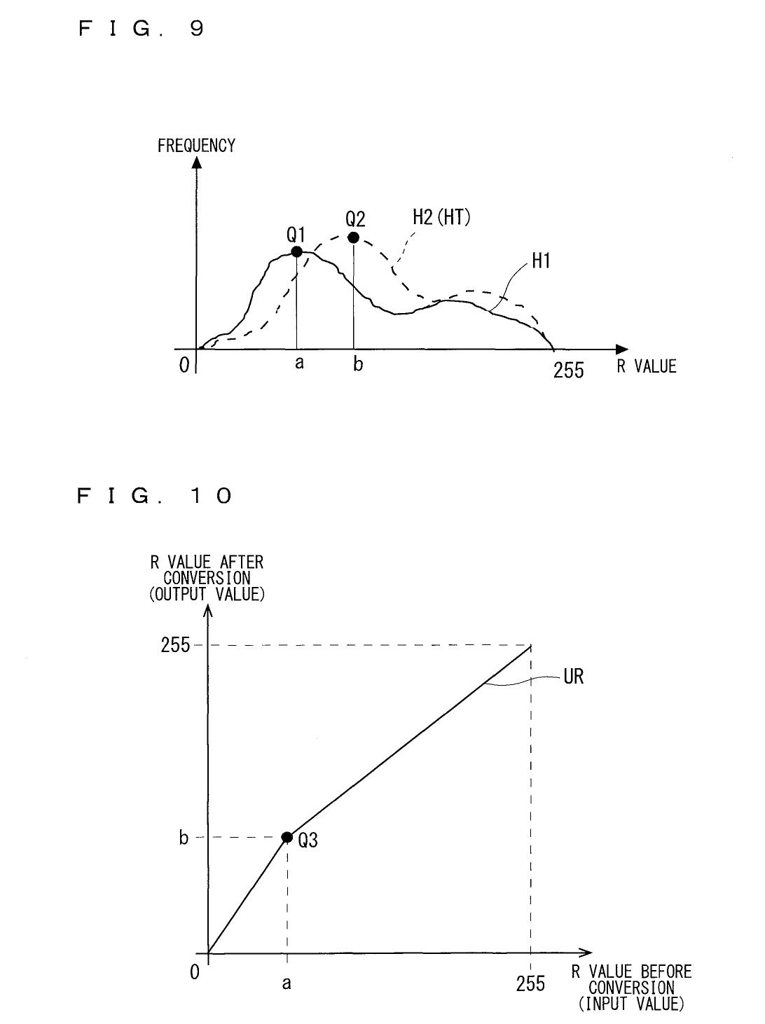

FIG. 9 is a chart for explaining a process for generating a converting gamma table UR (FIG. 10) using the non-cumulative histograms H1 and H2. The non-cumulative histogram H1 is equivalent to a non-cumulative histogram for the input image 1 (the subject image OG) and the non-cumulative histogram H2 is equivalent to a non-cumulative histogram for the input image 2. The input image 2 is also the target image TG. For this reason, the non-cumulative histogram H2 is also equivalent to a non-cumulative histogram HT.

A point Q1 serves to give a peak value of a frequency in the non-cumulative histogram H1 and a point Q2 serves to give a peak value of a frequency in the non-cumulative histogram H2. Moreover, an R value of a is a corresponding R value to the point Q1 and an R value of b is a corresponding R value to the point Q2.

FIG. 10 is a chart showing an example of the converting gamma table UR for the R value of the subject image OG (the input image 1). The converting gamma table UR has an input/output relationship (a conversion characteristic) for converting the R value of the input image 1 into the R value of the output image 3.

In the case in which an operation mode using the non-cumulative histogram in the generation of the converting gamma table is set, the image processing section 13 generates the converting gamma table based on the feature point such as the point Q1, Q2 or the like. More specifically, the image processing section 13 first identifies a point Q3 corresponding to the R value of a before the conversion and the R value of b after the conversion as shown in FIG. 10. Next, a polygonal line (a curve) for connecting the point Q3 to a point (0, 0) and a point (255, 255) respectively is identified to generate the converting gamma table UR. For example, a feature point for giving a peak value or the other extreme values or the like can be utilized for a feature point on the non-cumulative histogram to be used for generating the converting gamma table.

In the case in which the converting gamma table is generated based on the non-cumulative histogram as described above, the converting gamma table for causing the histograms for the respective pixel expression information about the input images 1 and 2 to approximate to each other is generated based on the feature point of the non-cumulative histogram. A matching condition for color data between the output images 3 and 4 is improved as compared with a matching condition for color data between the input images 1 and 2 through the generated converting gamma table. Even if the converting gamma table is generated by using the non-cumulative histogram, accordingly, the usability of the present invention is not impaired.

<(2-2-3) Plural Color Matching Processes in Different Color Spaces>

Next, description will be given to an operation of the image processing apparatus 200A in the case in which an operation mode for executing the color matching process at plural times in different color spaces is set. Prior to the description, explanation will be given to the case in which C (chroma) is used as a color space for the color matching process in a different color space from the color space in each of the above described RGB components.

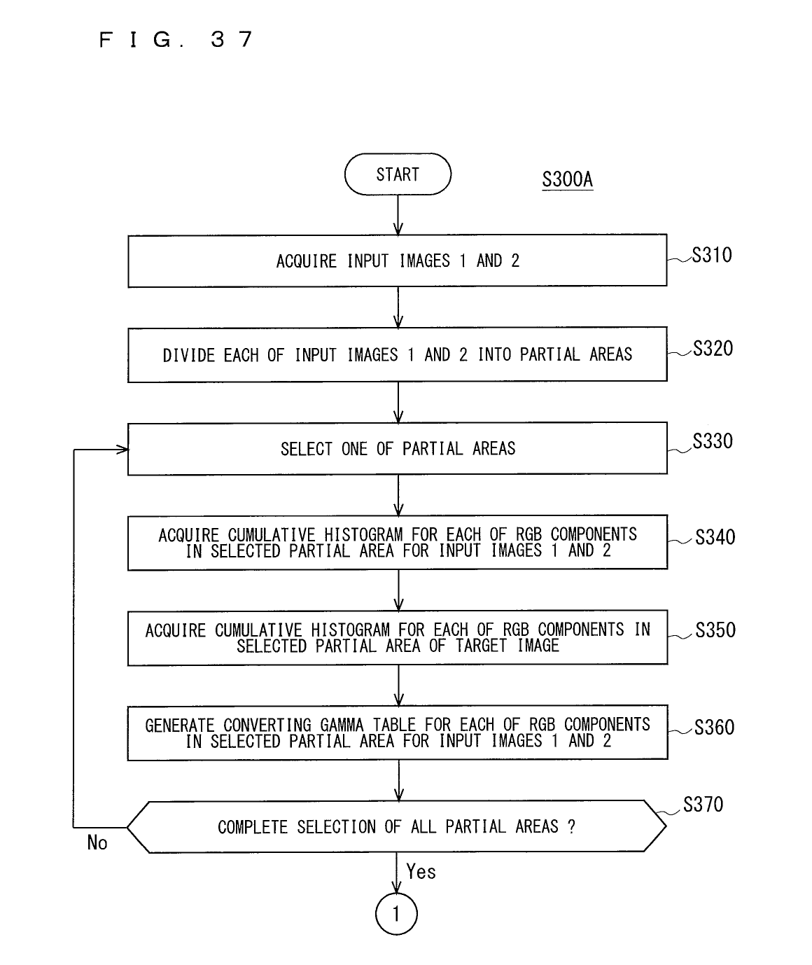

FIG. 36 is a diagram showing an example of an operational flow S200A for the image processing apparatus 200A according to the embodiment to execute the color matching process for the input images 1 and 2 by setting the chroma as pixel expression information about the generation of the converting gamma table. The operational flow shown in FIG. 36 is carried out, except for the processes in Steps S220 and S270, by the same process as in the case in which each of the RGB components to be the pixel expression information about the operational flow shown in FIG. 35 is replaced with the chroma.

When the operational flow S200A is started, the image processing section 13 acquires the input images 1 and 2 (Step S210). Next, the image processing section 13 converts the color spaces of the input images 1 and 2 from RGB to LCH (a lightness, a chroma, a hue) (Step S220), and acquires cumulative histograms of a C (chroma) component for the input images 1 and 2 (Step S230).

When the cumulative histogram of the C (chroma) component is acquired, the image processing section 13 acquires the cumulative histogram of the C (chroma) component for the target image which is previously generated or identified (Step S240). When the cumulative histogram is acquired, the image processing section 13 generates the converting gamma table of the C component for each of the input images 1 and 2 in the same manner as in the Step S140 (FIG. 35) (Step S250), and furthermore, converts the respective C components of the input images 1 and 2 by using the respective converting gamma tables which are generated (Step S260).

When the conversion is ended, the image processing section 13 inversely converts the color spaces of the input images 1 and 2 in which the C components are converted respectively from LCH to RGB, thereby generating the output images 3 and 4 (Step S270) to end the color matching process. The color matching process may be carried out based on both L (lightness) and C (chroma), for example.

In the case in which the image processing section 13 executes the plural color matching processes in the different color spaces, it first sets information about one of the RGB components, the lightness and the chroma for each of the input images 1 and 2 as the pixel expression information, thereby carrying out a first color matching process. Next, the image processing section 13 executes a second color matching process by setting, as the pixel expression information, information other than the information used in the first color matching process in the RGB components, the lightness and the chroma for each of the input images 1 and 2 subjected to the color matching process.

More specifically, the image processing section 13 first executes the color matching process for each of the RGB color components in accordance with the operational flow in FIG. 35, for example, and then executes a color matching process based on the C (chroma) component in accordance with an operational flow in FIG. 36. To the contrary, even if the color matching process based on the pixel expression information other than the RGB components is executed and the color matching process based on each of the RGB components is subsequently executed, the usability of the present invention is not impaired.

If the color matching process between the input images 1 and 2 is executed plural times in the different color spaces from each other, the color matching condition between the output images 3 and 4 after the conversion is improved more greatly as compared with the case in which only the color matching process in each of the RGB color spaces is carried out, for example.

<(2-2-4) Color Matching Process Using Partial Area>

Referring to the input images 1 and 2 shown in FIGS. 3 and 4 respectively, a histogram for pixel expression information in a whole image area is acquired and the color matching process is executed based on the histogram. Even if the color matching process is executed based on a histogram for each of an image in a part of an image area for the input image 1 and an image in a part of an image area for the input image 2, however, the usability of the present invention is not impaired.

It is sufficient that the image in a part of the image area for the input image 1 and the image in a part of the image area for the input image 2 include the same portion on an object respectively, and a size of the partial area for the input image 1 and a size of the partial area for the input image 2 may be different from each other, for example. For instance, in the case in which a part of the image area for each of the input images 1 and 2 which requires the color matching process is set to be a subject of the color matching process, the color matching process between the partial areas requiring the color matching process can be improved more greatly as compared with the case in which the color matching process is carried out based on the histogram for the whole image area.

The image processing section 13 acquires, as a partial area related to the generation of the histogram, area information designated by operating the operation section 42 through a user depending on the operation mode, and furthermore, generates the area information based on the image information about the input images 1 and 2 or the like depending on the operation mode. Even if the converting gamma table acquired based on the histogram for the partial area is applied to the other area such as the whole image area in addition to the partial area, for example, the usability of the present invention is not impaired.

<(2-2-4-1) Regarding Adoption of Common Area>

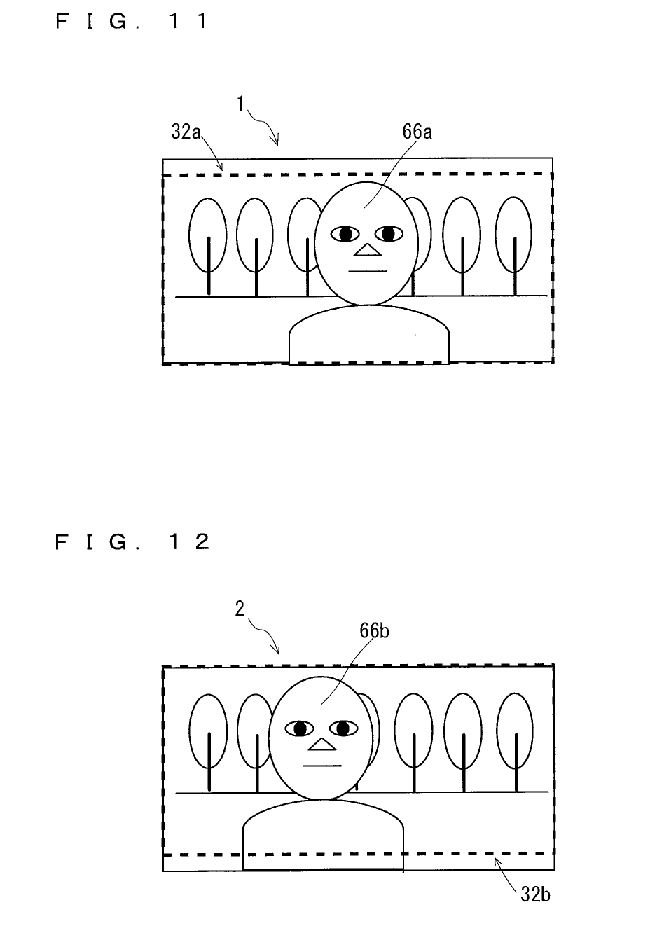

FIGS. 11 and 12 are views showing an example of common areas 32a and 32b in the input images 1 and 2 in the case in which the input images 1 and 2 have upper and lower parallaxes, for example. The common area 32a is an area contained by a rectangle shown in a broken line in the input image 1 and the common area 32b is an area contained by a rectangle shown in a broken line in the input image 2. Moreover, the common areas 32a and 32b are areas related to images obtained by capturing the same portion of the object in the input images 1 and 2, respectively. In other words, an image of the input image 1 in the common area 32a and an image of the input image 2 in the common area 32b are partial images corresponding to the same portion of the object, respectively.

The image processing section 13 acquires area information about a common area designated by a user through the operation section 42 or area information about the common area generated in the stereo calibration of the stereo camera 300 depending on an operation mode, thereby identifying the common areas 32a and 32b. Moreover, the image processing section 13 generates the area information about the common area based on a result of a pattern matching process between the input images 1 and 2 depending on the operation mode, thereby identifying the common areas 32a and 32b.

As a correlation calculation method to be used in the pattern matching process to be executed by the image processing section 13, for example, the NCC (Normalized Cross Correlation) method, the SAD (Sum of Absolute Difference) method, the POC (Phase Only Correlation) method or the like is adopted.

The stereo correction is previously executed over the stereo camera 300 and images for a calibration obtained by carrying out image-capturing of a calibration chart by means of the first camera 61 and the second camera 62 respectively on a predetermined image-capturing condition are used for the stereo calibration. In a stereo camera calibration, a common area between the calibration images is identified for the images, and furthermore, each parameter to be used in a process for removing an aberration of an image, a parallelization process and the like is obtained. Moreover, the parameter thus obtained and area information for identifying a common area between the calibration images are stored in the storage device 46. The image processing section 13 acquires area information about the common area prestored in the storage device 46, thereby identifying the common areas 32a and 32b for the input images 1 and 2.

<(2-2-4-2) Removal of Occlusion Area>

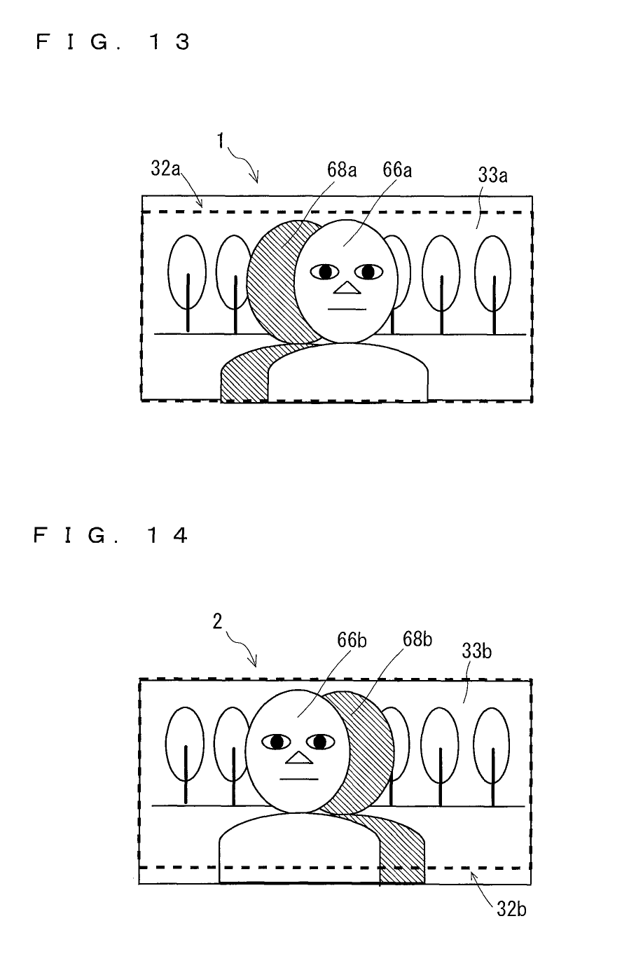

In addition to FIG. 11, FIG. 13 is a view illustrating an example of a partial area 33a from which an occlusion area 68a (a first occlusion area) shown in an oblique line in the common area 32a of the input image 1 is removed. In addition to FIG. 12, moreover, FIG. 14 is a view illustrating an example of the partial area 33b from which an occlusion area 68b (a second occlusion area) shown in an oblique line in the common area 32b of the input image 2 is removed.

The occlusion area 68a can be imaged by means of the first camera 61 and is an area for an image related to a background object which cannot be imaged by means of the second camera 62 due to a foreground object related to the foreground object image 66a. Similarly, the occlusion area 68b can be imaged by means of the second camera 62 and is an area for an image related to the background object which cannot be imaged by means of the first camera 61 due to the foreground object related to the foreground object image 66b.

In the case in which an operation mode corresponding to a color matching process based on a partial image from which the occlusion area is removed is set as the operation mode of the image processing apparatus 200A, the image processing section 13 identifies the occlusion areas 68a and 68b respectively by the execution of a corresponding point retrieval process between the input images 1 and 2 or the like, for example. The corresponding point retrieval process can be executed by a process for identifying representative points of the areas corresponding to each other by a pattern matching process using the correlation calculation method such as the SAD method or the POC method, or the like. The image processing section 13 executes the color matching process by a conversion for causing the respective histograms of the identified partial areas 33a and 33b to approximate to each other. According to the color matching process, the images in the occlusion areas 68a and 68b are not used for generating the histogram. For this reason, shapes of the respective histograms to be generated are closer to each other as compared with the case in which the occlusion area is used. According to the color matching process, therefore, it is possible to improve the color matching condition between the images more greatly. Even if an image of an area in which the occlusion area is removed from a common area, and furthermore, a partial image in which the occlusion area is removed from a whole area of an input image are adopted as a partial image from which the occlusion area is removed, for example, the usability of the present invention is not impaired.

<(2-2-5) Color Matching Process Using Divided Partial Areas>

FIG. 15 is a diagram showing an example of a plurality of partial areas (which will also be referred to as “blocks”) set to each of the input images 1 and 2. In FIG. 15, 12 blocks M1 to M12 are set. The image processing section 13 executes a color matching process using the divided partial areas depending on the operation mode of the image processing apparatus 200A. In the color matching process, the image processing section 13 divides the respective image areas of the input images 1 and 2 into the blocks (M1 to M12) as illustrated in FIG. 15.

The image processing section 13 identifies a focused block in the respective blocks obtained by the division of the image area for the input image 1 and a corresponding block in which an arrangement relationship corresponds to the focused block in the respective blocks obtained by the division of the image area for the input image 2, respectively. When the focused block and the corresponding block are identified, the image processing section 13 generates, for each of the focused block and the corresponding block, a converting gamma table for causing a frequency distribution of a histogram for pixel expression information about the focused block to relatively approximate to a frequency distribution of a histogram for the pixel expression information about the corresponding block.

The image processing section 13 applies the corresponding converting gamma table to each of the focused block and the corresponding block to convert a value of the pixel expression information, thereby executing a color matching process between the focused block and the corresponding block, that is, a color matching process for each block. The image processing section 13 executes the color matching process while changing the combination of the focused block and the corresponding block, thereby carrying out the color matching process between the input images 1 and 2.

According to the color matching process using the divided partial areas, there is executed the color matching process between the blocks corresponding to each other. Therefore, also in the case in which shading is generated in the input images 1 and 2, for example, the color matching condition after the color matching process can be improved more greatly as compared with the case in which the color matching process is executed based on the histogram for the whole image.

<Regarding Weighting Process>

The image processing section 13 assigns weights depending on mutual distances between the plurality of blocks to the converting gamma table for each block to perform a mutual application between the respective blocks, thereby acquiring a new converting gamma table for each block for the input images 1 and 2 depending on the operation mode. The image processing section 13 converts the value of the pixel expression information about each block based on the new converting gamma table thus acquired for each of the input images 1 and 2, thereby executing the color matching process for the input images 1 and 2.

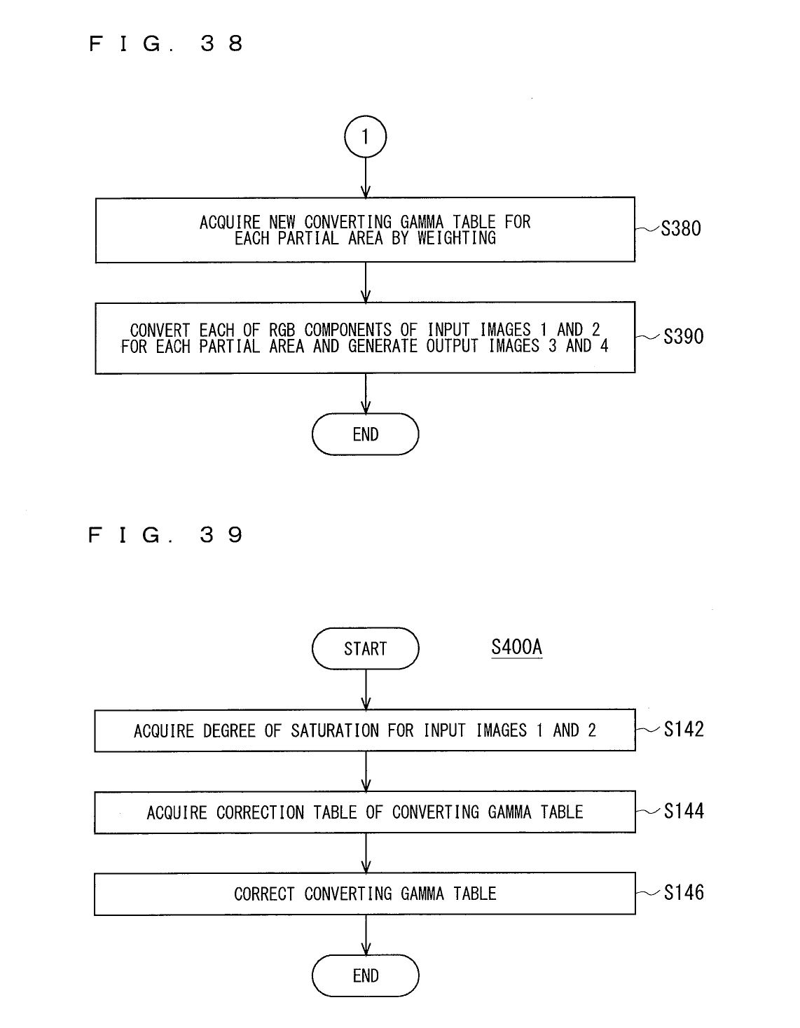

FIGS. 37 and 38 are diagrams showing an example of an operational flow S300A of the image processing apparatus 200A for executing a color matching process using the weighting process for each of the input images 1 and 2 which is divided into a plurality of partial areas. Moreover, FIG. 16 is a chart for explaining an example of weights to be applied to each of the partial areas, and w5 to w7 indicate weights of the respective blocks M5 to M7 to be applied to respective positions in a +X direction (FIG. 15) in the block M6.

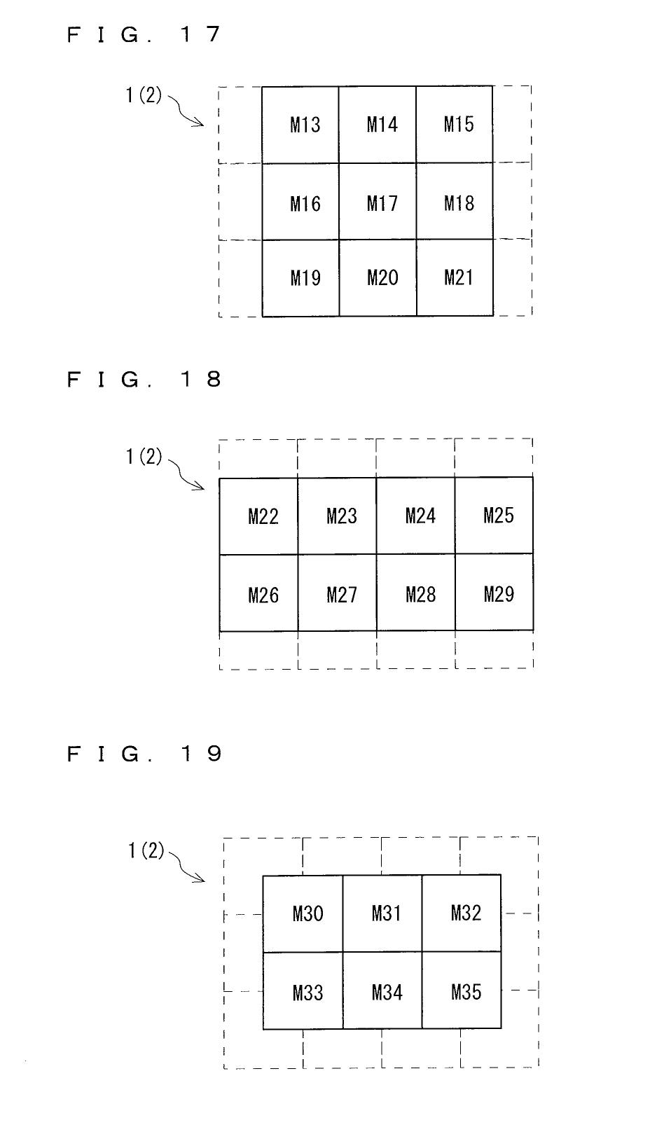

FIGS. 17 to 19 are diagrams showing blocks M13 to M21, blocks M22 to M29 and blocks M30 to M35 according to an example of the divided areas (blocks) in the input images 1 and 2, respectively. Moreover, FIG. 20 is a diagram for explaining an example of the weighting process in the partial areas by using the blocks M1, M13, M22 and M30. In FIG. 20, mutual overlapping portions of outer edges of the blocks M1, M13, M22 and M30 are shifted and displayed for convenience in order to enhance a visibility. Furthermore, a point PO1 is a central point of the area of the block M1. The operational flow S300A in FIGS. 37 and 38 will be described with appropriate reference to FIGS. 15 to 20.

When the operational flow S300A is started, the image processing section 13 acquires the input images 1 and 2 (Step S310) and divides each of the input images 1 and 2 into a plurality of partial areas (blocks) as shown in FIG. 15, for example (Step S320). Next, the image processing section 13 selects one of the partial areas (Step S330). When the selection of the partial area is completed, the image processing section 13 acquires a cumulative histogram for each of RGB components in the selected partial area for each of the input images 1 and 2 (Step S340).

Subsequently, the image processing section 13 acquires a cumulative histogram for each of RGB components for a previously generated or identified target image (Step S350). The image processing section 13 acquires, as a cumulative histogram for the block M6, a new cumulative histogram CH6_N for the block M6 which is calculated in accordance with Equation (1), for example, and acquires cumulative histograms for the other blocks in the same manner.

[Equation 1]

CH6_{—}N=CH6×8+CHAll (1)

wherein

CHAll=CH1+CH2+CH3+CH4+CH5+CH6+CH7+CH8+CH9+CH10+CH11+CH12

CH1 to CH12: cumulative histograms for blocks M1 to M12

CH6_N: new cumulative histogram for block M6

When the cumulative histogram is acquired, the image processing section 13 generates a converting gamma table for each of RGB components of the partial area selected for each of the input images 1 and 2 in the same manner as in the Step S140 (FIG. 35) (Step S360).

When the generation of the converting gamma table is completed for the partial area to be a processing subject, the image processing section 13 confirms whether the selection of all of the partial areas is completed or not (Step S370). As a result of the confirmation at the Step S370, if the selection of all of the partial areas is not completed, the image processing section 13 returns the processing to the Step S330.

As a result of the confirmation at the Step S370, if the selection of all of the partial areas is completed, the image processing section 13 acquires a new converting gamma table for each of the partial areas by weighting (Step S380). Specifically, the image processing section 13 acquires a new converting gamma table UR6N calculated in accordance with Equations (2) to (4) for the block M6, for example, and acquires new cumulative histograms for the other blocks in the same manner. In the case in which the block to be a processing subject is an area at an end of an area for an input image, however, a new converting gamma table is calculated in accordance with respective equations corresponding to the Equations (2) to (4) based on only an actually existent block.

[Equation 2]

SUM=w1+w2+w3+w5+w6+w7+w9+w10+w11 (2)

R=UR6×w6+UR2×w2+UR5×w5+UR7×w7+UR10×w10+UR1×w1+UR3×w3+UR9×w9+UR11×w11 (3)

UR6_{—}N=R/SUM (4)

wherein

wn: weight of block Mn (R component) (n: 1˜3, 5˜7, 9˜11)

URn: cumulative histogram of block Mn (R component)
(n: 1˜3, 5˜7, 9˜11)

UR6_N: new converting gamma table of block M6 (R component)

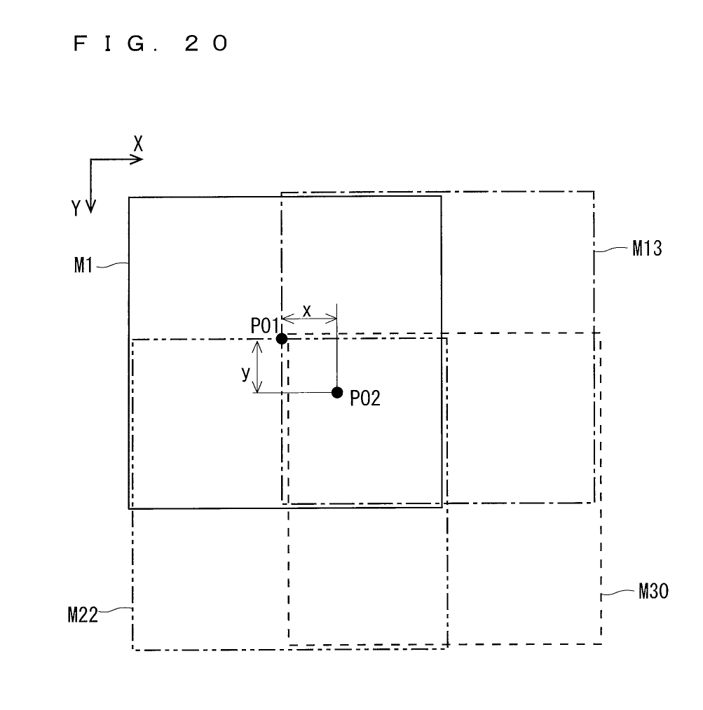

Referring to a method for generating a new converting gamma table, there is adopted a generating method depending on a division manner for dividing the input images 1 and 2 into a plurality of partial areas. For example, the image processing section 13 carries out the division of the blocks M1 to M12 (FIG. 15), the blocks M13 to M21 (FIG. 17), the blocks M22 to 29 (FIG. 18) and the blocks M30 to M35 (FIG. 19) respectively at the Step S320 depending on an operation mode. The image processing section 13 acquires a cumulative histogram in accordance with the Equation (1) for each of the blocks M1 to M12, and acquires, as a cumulative histogram of the block M13, a new cumulative histogram CH13_N for the block M13 which is calculated in accordance with Equation (5) for each of the blocks M13 to M35, for example, and acquires cumulative histograms for the other blocks in the same manner.

[Equation 3]

CH13_{—}N=CH13×8+CHAll (5)

wherein

CHAll=CH1+CH2+CH3+CH4+CH5+CH6+CH7+CH8+CH9+CH10+CH11+CH12

CH1 to CH13: cumulative histograms for blocks M1 to M13

CH13_N: new cumulative histogram for block M13

When a cumulative histogram is acquired for each of the blocks M1 to M35, the image processing section 13 acquires a converting gamma table UR_PO2 calculated in accordance with Equation (6) for a point PO2 in the block M1. The image processing section 13 calculates a converting gamma table for the other points in the block M1 in the same manner, thereby acquiring a converting gamma table for the block M1. The image processing section 13 generates converting gamma tables for the blocks M2 to M12 in the same manner as the block M1.

$$\begin{matrix}[ Equation 4 ] & \\ \begin{matrix}UR\_PO 2 = ( 1 - x ) \times ( 1 - y ) \times UR 1 + \\ x \times ( 1 - y ) \times UR 13 + \\ ( 1 - x ) \times y \times UR 22 + \\ x \times y \times UR 30\end{matrix} & ( 6 )\end{matrix}$$

wherein
values of halves of lengths in X and Y directions in each area are 1 UR_PO2: converting gamma table on point PO2
x: distance between point PO1 and point PO2 (X direction)
y: distance between point PO1 and point PO2 (Y direction)

When a new converting gamma table for each partial area is generated, the image processing section 13 converts a value of each of the RGB components in the input images 1 and 2 for each of the partial areas by using the new converting gamma table for each of the partial areas, thereby generating the output images 3 and 4 (Step S390) to end the color matching process.

In the case in which the converting gamma table is generated by a weighting process, a rapid change in color data in a boundary portion between the divided partial areas can be suppressed more greatly as compared with the case in which the weighting process is not carried out. Even if the weighting process is executed or is not executed, however, the usability of the present invention is not impaired.

<(2-3) Regarding Process for Correcting Degree of Saturation>

The image processing section 13 further executes a process for correcting a degree of saturation depending on an operation mode. The process for correcting a degree of saturation serves to cause a degree of saturation in any one of the input images 1 and 2 which has a lower degree of saturation to approximate to the degree of saturation of the other image, the degree of saturation expressing a rate of pixels having a saturated value of pixel expression information. In the present application, “saturation” indicates both the case in which the value of the pixel expression information has an upper limit of a range which can be expressed in a predetermined number of bits (which is also referred to as an “expression enabling scope”) and the case in which the same value is a lower limit of the range.

In the case in which the target image TG has a more saturated value of the pixel expression information on the upper limit side of the expression enabling scope than the subject image OG, a converting gamma table for increasing the value of the pixel expression information at the upper limit side of the subject image OG is generated by the process of the Step S140 in FIG. 35. In some cases in which the converting table is exactly applied to the subject image OG, an image of the subject image OG thus converted has an increased degree of discreteness of a distribution of a range at the upper limit side of the expression enabling scope and is an image in which a boundary portion having a value of pixel expression information changed is remarkable. The phenomenon occurs due to an interpolation process in the generation of the converting gamma table or the like, for example. More specifically, a portion in which the value of the pixel expression information after the conversion is 255 and a portion in which the value is 250 or the like, for example, are adjacent to each other so that the boundary portion is generated.

In the case in which the target image TG has the value of the pixel expression information which is saturated more greatly at the lower limit side of the expression enabling scope than the subject image OG, similarly, a converting gamma table for decreasing the value of the pixel expression information at the lower limit side of the subject image OG is generated. In some cases in which the converting table is exactly applied to the subject image OG, the image of the subject image OG thus converted has an increased degree of discreteness of a distribution of a range at the lower limit side of the expression enabling scope and is an image in which a boundary portion having the value of the pixel expression information changed is remarkable. More specifically, a portion in which the value of the pixel expression information after the conversion is zero and a portion in which the value is 5 or the like, for example, are adjacent to each other so that the boundary portion is generated.

In the image processing apparatus 200A, therefore, a process for correcting a degree of saturation which serves to saturate the subject image OG more greatly based on image information about the target image TG is carried out over the subject image OG and the target image TG which is saturated more greatly than the subject image OG. Consequently, it is possible to increase a possibility that a phenomenon in which the boundary portion (which is also referred to as a “color step”) is remarkable can be improved.

<(2-3-1) Process for Correcting Degree of Saturation Using Converting Gamma Table>

The process for correcting a degree of saturation is carried out based on the converting gamma table to be generated for the subject image OG and the target image TG.

FIG. 39 is a diagram showing an example of an operational flow S400A for the image processing apparatus 200A to acquire the converting gamma table related to the process for correcting a degree of saturation. The image processing section 13, in such operation, first acquires the degrees of saturation for the input images 1 and 2 (Step S142).

FIGS. 21 to 24 are charts for explaining an example of the degrees of saturation acquired based on the converting gamma tables. As described above, these converting gamma tables are generated based on the target image TG and the subject image OG which is saturated more greatly than the target image TG. A converting gamma table UR (UG, UB) in FIG. 21 (22, 23) is a converting gamma table for the R (G, B) component of the input image 1 (the subject image OG) generated at the Step S140 in FIG. 35 or the like.

Similarly, a converting gamma table VR (VG, VB) in FIG. 24 is a converting gamma table for the R (G, B) component of the input image 2 (the target image TG). The respective converting gamma tables VR, VG and VB have conversion characteristics which are mutually equal to each other, and have a gradient of 1.

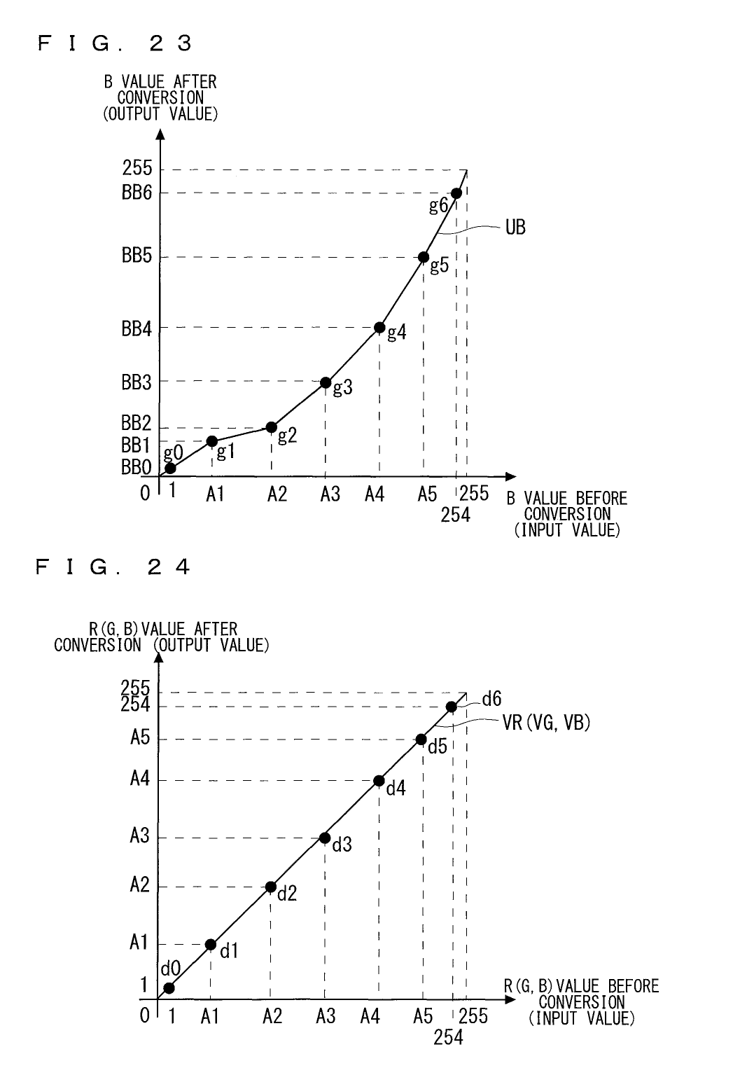

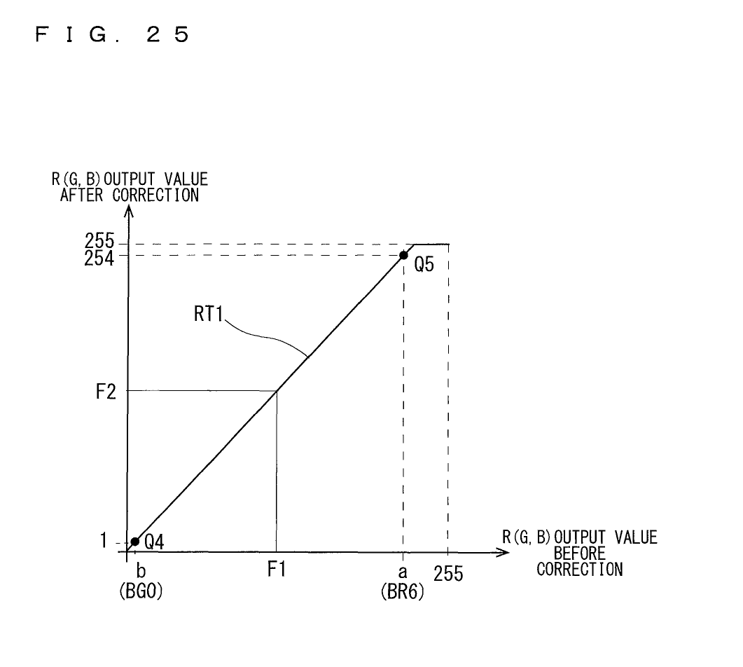

The R values before the conversion (the input values) of 1, A1 to A5 and 254 correspond to points e0 to e6 on the converting gamma table UR (FIG. 21) respectively, and furthermore, the R values after the conversion (the output values) of BR0 to BR6 correspond thereto respectively. Moreover, the G values before the conversion (the input values) of 1, A1 to A5 and 254 correspond to points f0 to f6 on the converting gamma table UG (FIG. 22) respectively, and furthermore, the G values after the conversion (the output values) of BG0 to BG6 correspond thereto respectively. Furthermore, the B values before the conversion (the input values) of 1, A1 to A5 and 254 correspond to points g0 to g6 on the converting gamma table UB (FIG. 23) respectively, and furthermore, the B values after the conversion (the output values) of BB0 to BB6 correspond thereto respectively.

Moreover, the R (G, B) values before the conversion (the input values) of 1, A1 to A5 and 254 correspond to points d0 to d6 on the converting gamma table VR (VG, VB) in FIG. 24 respectively, and furthermore, the R (G, B) values after the conversion (the output values) of 1, A1 to A5 and 254 correspond thereto respectively.

The image processing section 13 acquires a degree of saturation based on the output value of each of the converting gamma tables corresponding to an end of a range of an input value in the converting gamma table UR (UG, UB, VR, VG, VB) at Step 142 of FIG. 39.

The “end of a range” of the converting gamma table generally indicates a portion (or a scope) corresponding to a value which is larger than a lower limit of the range (0% in a percentage display) by a predetermined minute width and a portion (or a scope) corresponding to a value which is smaller than an upper limit of the range (100% in the same percentage display) by a predetermined minute width. For instance, in the examples shown in FIGS. 21 to 24, the image processing section 13 adopts the least significant bit (that is, 1) expressing the R (G, B) value as the minute width, thereby using the values of 1 (the lower limit side) and 254 (the upper limit side) as the ends of the range.

Specifically, the image processing section 13 acquires, as a degree of saturation on the upper limit side, a minimum one of the output values BR6, BG6, BB6 and 254 corresponding to the input value of 254, that is, the output value BR6 in the converting gamma tables UR, UG, UB, VR, VG and VB in FIGS. 21 to 24. Furthermore, the image processing section 13 acquires, as a degree of saturation on the lower limit side, a maximum one of the output values BR0, BG0, BB0 and 1 corresponding to the input value of 1, that is, the output value BG0.

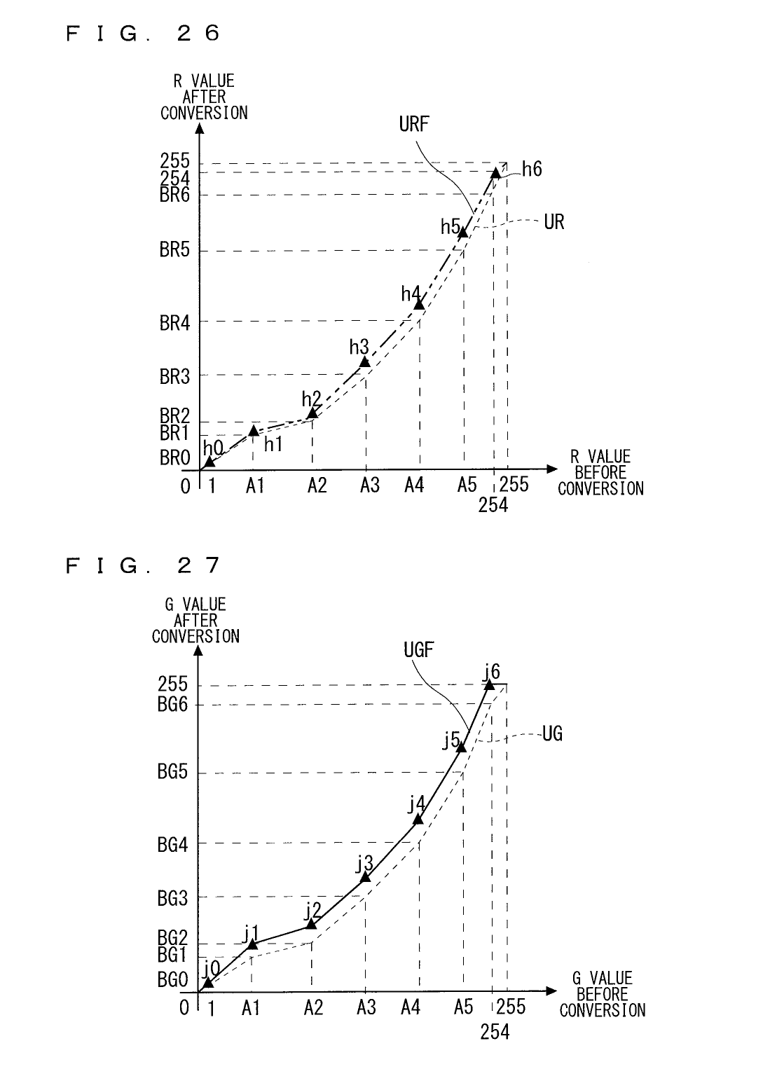

When the degree of saturation is acquired, the image processing section 13 acquires the correction table RT1 (FIG. 25) for correcting the converting gamma tables UR (UG, UB, VR, VG, VB) respectively based on the degree of saturation thus acquired (Step S144).

FIG. 25 is a chart showing an example of the correction table RT1 for correcting the converting gamma table. In the correction table RT1, a point Q4 corresponds to an output value BG0 (a value b) acquired as the degree of saturation on the lower limit side and an output value of 1 after the correction. Moreover, a point Q5 corresponds to an output value BR6 (a value a) acquired as the degree of saturation on the upper limit side and an output value of 254 after the correction.

The image processing section 13 sets the correction table RT1 based on the points Q4 and Q5. Specifically, the correction table RT1 is set based on a straight line connecting the points Q4 and Q5 which is expressed in Equation (7), for example. The upper limit of the output value after the correction is 255.

[Equation 5]

F2=(F1−b)/(a−b)×253+1 (7)

wherein
F1: output value of R (G, B) before correction, (F1: 0˜255)
F2: output value of R (G, B) after correction, (F2: 0˜255)
a: degree of saturation on upper limit side
b: degree of saturation on lower limit side

FIGS. 26, 27 and 28 are charts showing an example of converting gamma tables URF, UGF and UBF after the correction which are obtained by correcting the converting gamma tables UR, UG and UB for an R value, a G value and a B value of the subject image OG through the correction table RT1, respectively. Moreover, FIG. 29 is a chart showing an example of converting gamma tables VRF, VGF and VBF after the correction which are obtained by correcting the converting gamma tables VR, VG and VB for an R value, a G value and a B value of the target image TG itself through the correction table RT1, respectively.

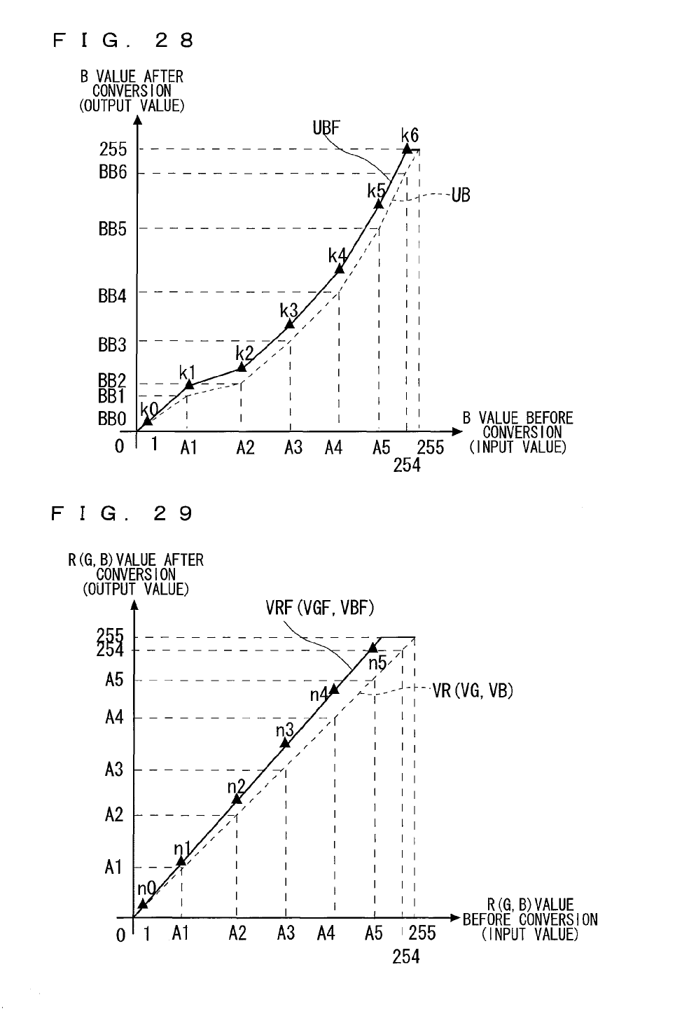

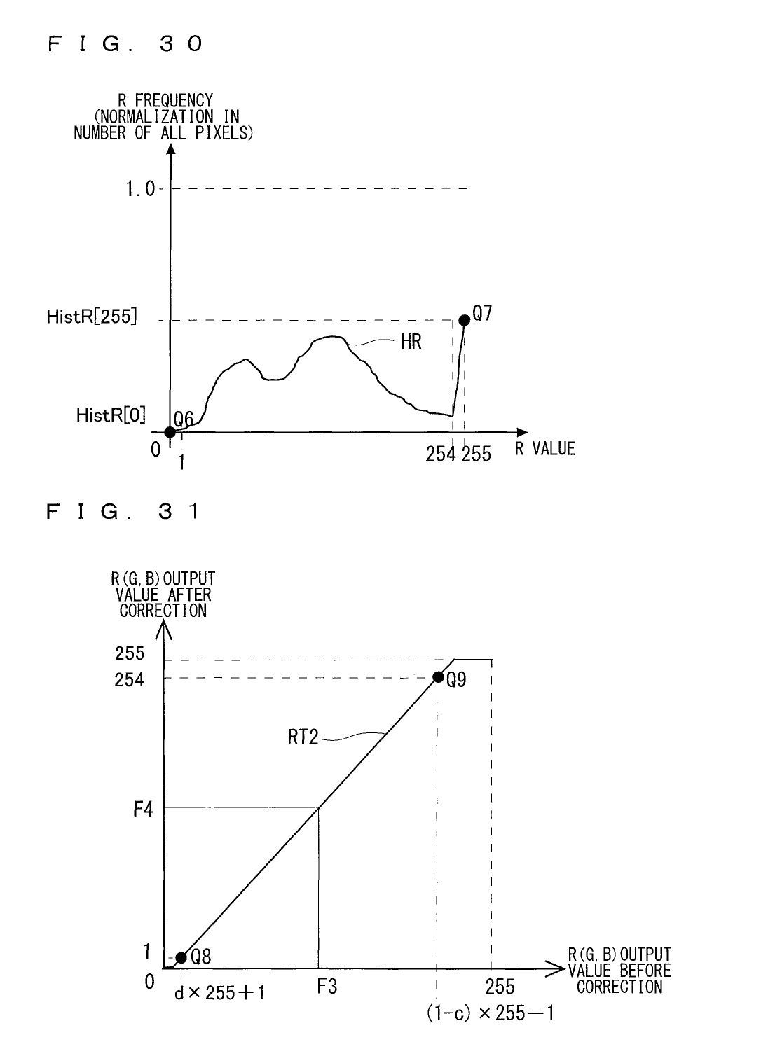

The image processing section 13 corrects each converting gamma table UR (UG, UB, VR, VG, VB) by using the correction table RT1 when the correction table RT1 is obtained (Step S146 of FIG. 39). By the correction, the image processing section 13 acquires the converting gamma tables URF (FIG. 26), UGF (FIG. 27), UBF (FIG. 28), VRF, VGF and VBF (FIG. 29 respectively) after the correction and ends the process for acquiring the converting gamma table after the correction.

Each converting gamma table before the correction is corrected based on the common correction table RT1. Consequently, it is possible to suppress the generation of a color step in each converting gamma table before the correction.

Points h0 to h5 in the converting gamma table URF correspond to the points e0 to e6 (FIG. 21), respectively. Similarly, points j0 to j6 in the converting gamma table UGF correspond to the points f0 to f6 (FIG. 22), respectively. Moreover, points k0 to k6 in the converting gamma table UBF correspond to the points g0 to g6, respectively. Furthermore, points n0 to n5 in the converting gamma table VRF (VGF, VBF) correspond to the points d0 to d5 (FIG. 24), respectively.

As shown in FIGS. 26 to 29, the converting gamma tables URF, UGF, UBF, VRF, VGF and VBF after the correction have a conversion characteristic (an input/output relationship) to saturate an image to be a correction subject more greatly as compared with the converting gamma tables UR, UG, UB, VR, VG and VB before the correction, respectively.

The converting gamma tables which are acquired are used respectively to convert the input images 1 and 2 so that the color matching between the input images 1 and 2 is carried out, and furthermore, a color step on the upper limit side and the lower limit side of the saturation in the output images 3 and 4 after the conversion can be suppressed. In the color matching, moreover, even if a whiteout condition or the like is present on only one of the input images 1 and 2 due to a difference in an exposure control in image-capturing of the first camera 61 and the second camera 62, for example, it is possible to carry out the color matching between the input images 1 and 2.

The color step on the upper limit side of the saturation can be recognized more easily than the color step on the lower limit side of the saturation. Accordingly, even if the correction table RT1 is generated based on only the degree of saturation on the upper limit side of the saturation, for example, the usability of the present invention is not impaired. Even if the correction table RT1 is generated based on only the degree of saturation on the lower limit side of the saturation depending on a requirement specification for the image processing apparatus 200A, moreover, the usability of the present invention is not impaired.

<(2-3-2) Process for Correcting Degree of Saturation Using Histogram>

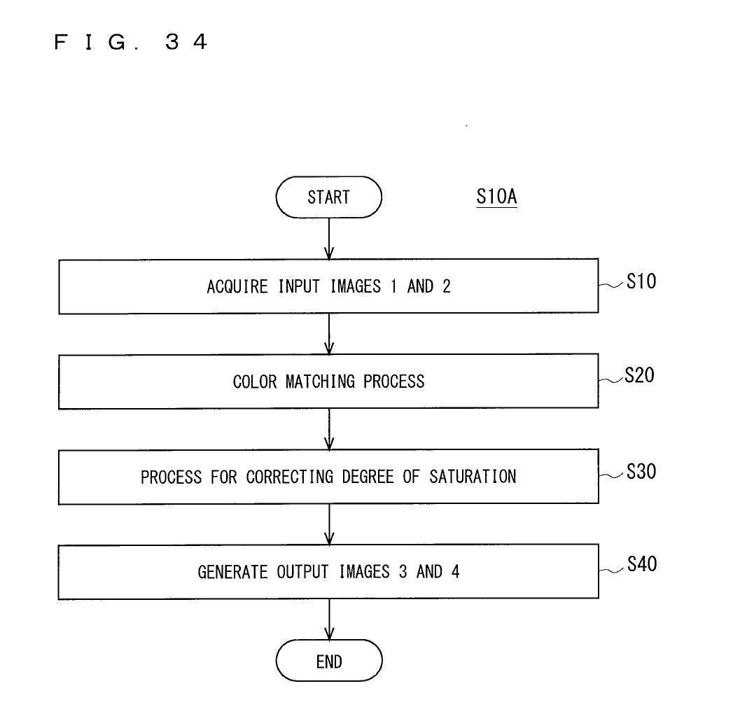

The image processing section 13 generates the same correction table RT2 (FIG. 31) by using a histogram depending on an operation mode. More specifically, the image processing section 13 acquires a degree of saturation based on a frequency of a histogram related to pixel expression information about either of the input images 1 and 2 which has a higher degree of saturation corresponding to an end of a range of the pixel expression information in the histogram, and executes the process for correcting a degree of saturation. The image processing section 13 acquires the degree of saturation at the Step 142 of FIG. 39.

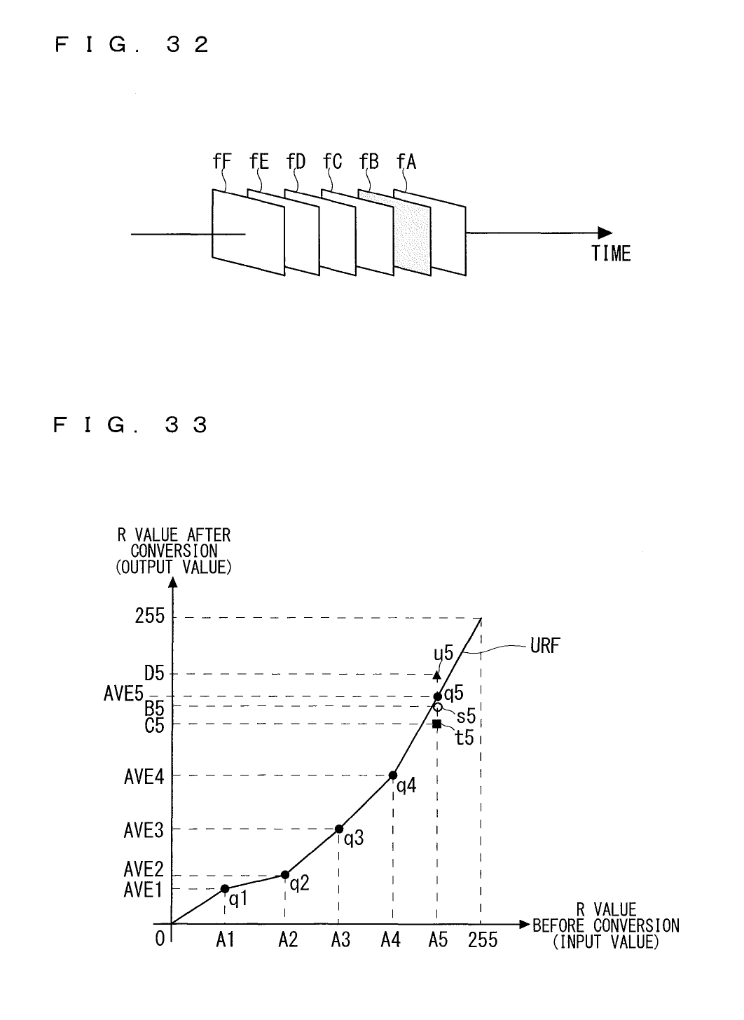

The “end of a range” of the histogram generally indicates a portion (or a scope) corresponding to a value which is larger than a lower limit of the range (0% in a percentage display) by a predetermined minute width and a portion (or a scope) corresponding to a value which is smaller than an upper limit of the range (100% in the same percentage display) by a predetermined minute width. The image processing section 13 adopts a value of 0 as the minute width, thereby using the values of 0 (the lower limit side) and 255 (the upper limit side) as the ends of the range in FIG. 30 which will be described below, for example.

FIG. 30 is a chart for explaining an example of the degree of saturation which is acquired based on a non-cumulative histogram. FIG. 30 shows a non-cumulative histogram HR for an R value. An R value corresponding to a point Q7 is 255 to be an upper limit in an expression enabling scope, and a normalized frequency is HistR [255]. An R value corresponding to a point Q6 is 0 to be a lower limit of the expression enabling scope, and a normalized frequency is HistR [0].

The image processing section 13 acquires a degree of saturation to be used in the generation of the correction table RT2 based on a non-cumulative histogram for each of the RGB components in each of the input images 1 and 2. The image processing section 13 acquires a maximum value d in the respective frequencies at the end of the range (the lower limit side) as a degree of saturation for the end of the range (the lower limit side). Moreover, the image processing section 13 acquires a maximum value c in the respective frequencies at the end of the range (the upper limit side) as a degree of saturation for the end of the range (the upper limit side). The image processing section 13 can acquire the maximum values c and d based on a cumulative frequency of cumulative histograms corresponding to the values of 0 and 1 (the lower limit side) and the values of 254 and 255 (the upper limit side) by using the respective values as the ends of the range. Accordingly, the image processing section 13 can also acquire the degrees of saturation (the upper limit side and the lower limit side) by using the cumulative histogram.

When the degree of saturation is acquired, the image processing section 13 acquires the correction table RT2 (FIG. 31) for correcting the converting gamma tables UR (UG, UB, VR, VG, VB) based on the degree of saturation thus acquired respectively at the Step S144 of FIG. 36.

FIG. 31 is a chart showing an example of the correction table RT2 for correcting the converting gamma table. In the correction table RT2, a point Q8 is a corresponding point to an output value of d×255+1 calculated based on the output value d acquired as the degree of saturation on the end of the range (the lower limit side) and the output value of 1 after the correction. Moreover, a point Q9 is a corresponding point to an output value of (1−c)×255−1 calculated based on the output value c acquired as the degree of saturation on the end of the range (the upper limit side) and the output value of 254 after the correction.

The image processing section 13 sets the correction table RT2 based on the point Q8 and the point Q9. Specifically, the correction table RT2 is acquired based on a straight line connecting the point Q8 and the point Q9 which is expressed in accordance with Equation (8), for example. An upper limit of the output value after the correction is 255.

[Equation 6]

F4=(F3−d×255−1)×253/(1−c−d)×255−2)+1 (8)

wherein
F3: output value of R (G, B) before correction, (F3: 0˜255)
F4: output value of R (G, B) after correction, (F4: 0˜255)
c: degree of saturation on upper limit side
d: degree of saturation on lower limit side

When the correction table RT2 is acquired, the image processing section 13 corrects the converting gamma tables for the RGB color components of the input images 1 and 2 respectively by using the correction table RT2 in the same manner as the correction table RT1 (FIG. 25). Then, the image processing section 13 converts the RGB color components of the input images 1 and 2 by using the respective converting gamma tables after the correction, thereby generating the output images 3 and 4 which are subjected to the color matching process and the process for correcting a degree of saturation.

As described above, the degree of saturation acquired based on the histogram is used so that the correction table RT2 is generated and the respective converting gamma tables can be corrected.

<(2-4) Regarding Color Matching Process in Chronological Image>

In the case in which the stereo camera 300 acquires a chronological image based on the control of the image processing apparatus 200A, the image processing apparatus 200A can execute the color matching process based on other input images captured at a time different from a time when the input images 1 and 2 to be the subjects of the color matching process have been captured.

FIG. 32 is a view for explaining a concept of the chronological image, and images fA to fF are chronological images captured continuously in a predetermined frame rate. The image fB is an image at a current time.

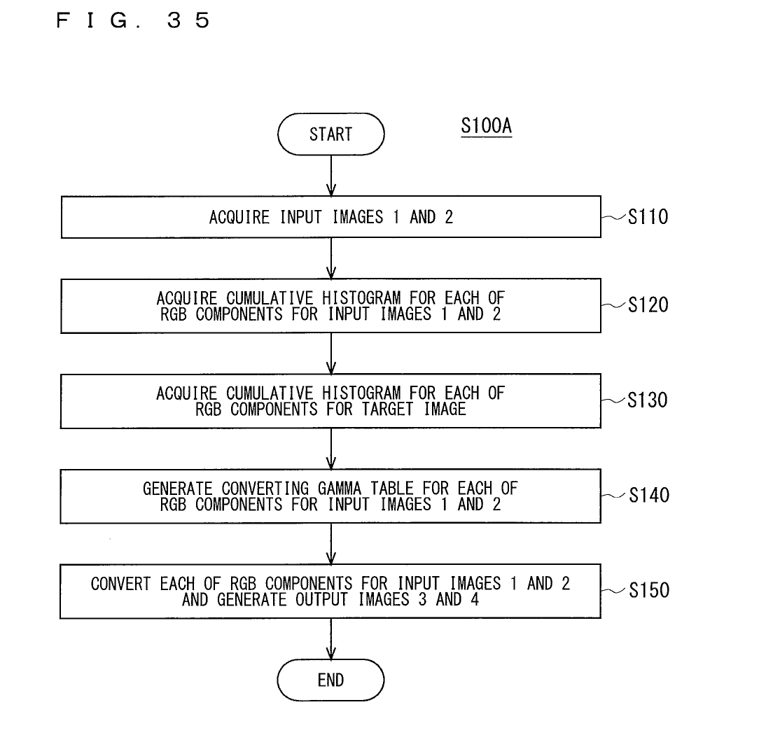

FIG. 33 is a chart showing a converting gamma table URF for an R value according to an example of a converting gamma table to be acquired based on the chronological image. Points s5, t5 and u5 are identified by an R input value A5 and R output values B5, C5 and D5 after the conversion corresponding to the input value A5 in converting gamma tables for the images fB, fC and fD, respectively. Moreover, a point q5 causes the input value A5 to correspond to an average value AVE5 of the output values B5 to D5 which are calculated in accordance with Equation (9). The image processing section 13 acquires an average value of the respective output values of the converting gamma table in each of the chronological images acquired in accordance with Equation (9) as each output value after the conversion in a new converting gamma table URF for a current input image, thereby generating the converting gamma table URF.

[Equation 7]

AVEn=(Bn+Cn+Dn)/3 (9)

wherein
AVEn: new R value after conversion corresponding to R value An of current input image
Bn: R value after conversion corresponding to R value An of current input image
Cn: R value after conversion corresponding to R value An of input image before 1 time
Dn: R value after conversion corresponding to R value An of input image before 2 time

Consequently, it is possible to gently change a color between chronologically continuous stereo images, thereby forming a chronological stereo image having no uncomfortableness. By applying the process to a chronological color matching process in a stereo process using a chronological image captured by a single camera in place of the chronological image captured by the stereo camera, it is also possible to produce the same effects.

As described above, according to the image processing apparatus 200A, the frequency distribution of the histogram for the input image 1 is caused to relatively approximate to the frequency distribution of the histogram for the input image 2 in relation to the input images 1 and 2 obtained by carrying out the image-capturing of an object so that the color matching process for the input image 1 and the input image 2 is executed. The color matching process can be carried out every image-capturing of the object because it does not require a dedicated calibration chart. For this reason, it is possible to easily execute the color matching process between the images obtained by carrying out the image-capturing of the object, respectively irrespective of an illumination condition for the object.

<Regarding Variant>

Although the embodiment according to the present invention has been described above, the present invention is not restricted to the embodiment but various changes can be made.

For example, the image processing system 100A has the structure implemented by executing a program through a general-purpose computer by the image processing apparatus 200A in the image processing system 100A. In place of the structure, however, the image processing system 100A may be implemented as a system including the stereo camera 300 and the image processing apparatus 200A in a device such as a digital camera, a digital video camera or a personal digital assistance.

In the process for correcting a degree of saturation, moreover, the converting gamma table for the color matching process for collectively executing the color matching process and the process for correcting a degree of saturation is generated and applied to the input images 1 and 2. Even if the color matching process including no process for correcting a degree of saturation and the process for correcting a degree of saturation are executed sequentially, however, the usability of the present invention is not impaired. The sequential process is implemented by a process for first generating each intermediate image by applying the color matching process including no process for correcting a degree of saturation to the input images 1 and 2 and then applying a correction table such as the correction table RT1 (FIG. 25) or the correction table RT2 (FIG. 31) to a color component of the intermediate image, thereby generating the output images 3 and 4 having the degrees of saturation corrected, or the like.

### DESCRIPTION OF THE REFERENCE NUMERALS

100A image processing system
200A image processing apparatus
300 stereo camera
1, 2 input image
CH1, CH2, CHT cumulative histogram
H1, H2, HT non-cumulative histogram
UR, UG, UB, VR, VG, VB converting gamma table
URF, UGF, UBF, VRF, VGF, VBF converting gamma table
RT1, RT2 correction table
OG subject image
TG target image

1-23. (canceled)

24. An image processing apparatus comprising:
an acquisition section for acquiring a first image and a second image in which an object is captured; and
a processing section for executing a color matching process between said first image and said second image by a conversion for causing a frequency distribution of a first histogram for pixel expression information about said first image to relatively approximate to a frequency distribution of a second histogram for pixel expression information about said second image,
wherein said processing section further executes a saturation degree correction process for causing a degree of saturation in any one of said first image and said second image which has a lower degree of saturation to approximate to said degree of saturation of the other image, said degree of saturation expressing a rate of pixels having a saturated value of said pixel expression information.

25. The image processing apparatus according to claim 24, wherein when a converting gamma table is defined with an input/output relationship for causing each value of said pixel expression information about said other image before said conversion to correspond to each value of the pixel expression information after said conversion,
said processing section executes said saturation degree correction process based on an output value of the converting gamma table corresponding to an end of a range of an input value in said converting gamma table.

26. The image processing apparatus according to claim 24, wherein said processing section executes said saturation degree correction process based on a frequency of a histogram for said pixel expression information about said other image, said frequency corresponding to an end of a range of said pixel expression information in the histogram.

27. The image processing apparatus according to claim 24, wherein said processing section executes said color matching process by setting any piece of information among RGB components, a lightness and a chroma for said first image and said second image as said pixel expression information, and
further executes said color matching process by setting, as said pixel expression information, a piece of information other than said any piece of information among said RGB components, said lightness and said chroma for said first image and said second image which are subjected to the color matching process.

28. The image processing apparatus according to claim 24, wherein for a focused block in blocks obtained by dividing an image area of said first image into a plurality of blocks and a corresponding block in blocks obtained by dividing an image area of said second image into said plurality of blocks, said corresponding block having an arrangement relationship corresponding to the focused block,
said processing section executes a color matching process between said focused block in said first image and said corresponding block in said second image by a conversion for each block which causes a frequency distribution of a histogram for said pixel expression information about said focused block to relatively approximate to a frequency distribution of a histogram for said pixel expression information about said corresponding block.

29. The image processing apparatus according to claim 28, wherein for each of said first image and said second image, said processing section
(a) acquires a new conversion characteristic of said conversion for each block for each of said plurality of blocks by assigning weights in accordance with mutual distances between said plurality of blocks to said conversion characteristic of said conversion for each of said plurality of blocks and performing a mutual application between said plurality of blocks, and
(b) converts a value of said pixel expression information based on said new conversion characteristic of said conversion for each block for each of said plurality of blocks.

30. An image processing apparatus comprising:
an acquisition section for acquiring a first image and a second image in which an object is captured; and
a processing section for executing a color matching process between said first image and said second image by a conversion for causing a frequency distribution of a first histogram for pixel expression information about said first image to relatively approximate to a frequency distribution of a second histogram for pixel expression information about said second image,
wherein said processing section executes said color matching process based on a first part of said first image and a second part of said second image, and
wherein said first part is a portion of said first image other than a first occlusion area for said second image, and said second part is a portion of said second image other than a second occlusion area for said first image.

31. The image processing apparatus according to claim 30, wherein said processing section executes a corresponding point retrieval process between said first image and said second image, thereby identifying said first occlusion area and said second occlusion area, respectively.

32. An image processing apparatus comprising:
an acquisition section for acquiring a first image and a second image in which an object is captured; and
a processing section for executing a color matching process between said first image and said second image by a conversion for causing a frequency distribution of a first histogram for pixel expression information about said first image to relatively approximate to a frequency distribution of a second histogram for pixel expression information about said second image,
wherein said processing section sets, as said target image, either of said first image and said second image which is captured by a higher-resolution image capturing system and executes said color matching process by a conversion for causing said frequency distribution of said first histogram and said frequency distribution of said second histogram to approximate to a frequency distribution of a histogram for said pixel expression information about said target image.

33. An image processing apparatus comprising:
an acquisition section for acquiring a first image and a second image in which an object is captured; and
a processing section for executing a color matching process between said first image and said second image by a conversion for causing a frequency distribution of a first histogram for pixel expression information about said first image to relatively approximate to a frequency distribution of a second histogram for pixel expression information about said second image,
wherein said processing section sets, as said target image, either of said first image and said second image which has smaller color fogging and executes said color matching process by a conversion for causing said frequency distribution of said first histogram and said frequency distribution of said second histogram to approximate to a frequency distribution of a histogram for said pixel expression information about said target image.

34. An image processing apparatus comprising:
an acquisition section for acquiring a first image and a second image in which an object is captured; and
a processing section for executing a color matching process between said first image and said second image by a conversion for causing a frequency distribution of a first histogram for pixel expression information about said first image to relatively approximate to a frequency distribution of a second histogram for pixel expression information about said second image,
wherein said acquisition section acquires a third image and a fourth image captured at a time different from a time when said first image and said second image have been captured, and
wherein said processing section executes said color matching process between said third image and said fourth image to acquire a conversion characteristic and corrects a conversion characteristic of said color matching process between said first image and said second image based on said conversion characteristic obtained by said color matching process between said third image and said fourth image.
